(19) United States
(12) Patent Application Publication
(10) Pub. No.: US 2010/0247207 A1
(43) Pub. Date: Sep. 30, 2010

(54) TAPE CASSETTE

(75) Inventors: Akira Sago, Seto-shi (JP); Takashi Horiuchi, Kariya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/732,247

(22) Filed: Mar. 26, 2010

(30) Foreign Application Priority Data
Mar. 31, 2009 (JP) 2009-088241

(51) Int. Cl. B41J 35/28

(52) U.S. Cl. 400/207

(57) ABSTRACT

A tape cassette that includes a housing having a top case and a bottom case, a tape, a printer head insertion portion, an arm portion including a first wall portion and a second wall portion extending perpendicularly upwards from a bottom wall of the bottom case, a first width direction regulating portion and a first print surface side regulating portion provided respectively provided on the second wall portion to restrict a movement of the tape in a tape width direction and toward a print surface side of the tape, a first lower joining portion provided on an upper end of the first width direction regulating portion, and a first upper joining portion provided on the top case to join with the first lower joining portion at a position that corresponds to a position of the first lower joining portion when the top case and the bottom case are joined.

### CROSS-REFERENCE TO RELATED APPLICATION

This application claims priority to Japanese Patent Application No. 2009-088241 filed on Mar. 31, 2009, the disclosure of which is herein incorporated by reference in its entirety.

### BACKGROUND

The present invention relates to a tape cassette that is detachably installed in a tape printer.

A tape cassette is known that is configured to be detachably installed in a cassette housing portion of a tape printer. This type of tape cassette normally has a structure in which a print tape, which is a print medium, and an ink ribbon for printing are mounted in a box-like cassette case formed by a top case and a bottom case.

When printing is performed, the tape cassette is installed in the cassette housing portion of the tape printer, and the print tape is fed along a predetermined feed path. More specifically, the print tape is first pulled out from a tape roll. After a print head of the tape printer performs printing on the print tape using the ink ribbon, the print tape is discharged to the outside of the tape printer. When the print tape is being fed, usually, a movement of the print tape in a tape width direction is restricted by an upper wall of the top case and a bottom wall of the bottom case. Further, a tape cassette is known in which the top case and the bottom case are each provided with a guide regulating piece that restricts a movement of a print tape in a tape width direction. Furthermore, a tape cassette is known in which the bottom case is provided with a tape holder. After printing is performed on a print tape and a double-sided adhesive tape is bonded on the print tape, the print tape passes through the tape holder.

### SUMMARY

With a cassette case formed by a top case and a bottom case, when the top case is not sufficiently pressed and fitted into the bottom case, the top case and the bottom case may not be joined at a correct position. In other words, the top case may be in a raised state with respect to the bottom case. Further, when the top case and the bottom case each have a dimensional error, in some cases, the dimensional errors may combine to be worse as a result of joining the top case and the bottom case.

In either case, with the tape cassette in which the movement of the tape in the tape width direction is restricted by the top wall and the bottom wall, or with the tape cassette described above, a distance between the top wall and the bottom wall, or a distance between the guide regulating pieces of the top case and the bottom case in the tape width direction may become longer than a correct distance. Then, the restriction in the tape width direction may not be sufficient. As a result, the print tape may deviate in the tape width direction, and a center position of printing by the print head in the vertical direction and a center position of the print tape in the tape width direction may be misaligned. Thus, a good printing result may not be obtained. Further, with the tape cassette described above, after the double-sided adhesive tape has been bonded to the print tape, the tape holder can restrict and guide the print tape. However, on the feed path before the double-sided adhesive tape has been bonded, a problem similar to that described above may occur.

An object of the present invention is to provide a tape cassette that is capable of appropriately restricting a movement of a print medium tape in a tape width direction.

Exemplary embodiments of the present invention herein provide a tape cassette that includes a housing, a tape, a printer head insertion portion, an arm portion, a first width direction regulating portion, a first print surface side regulating portion, a first lower joining portion, and a first upper joining portion. The housing includes a top case and a bottom case, the top case including a top wall, and the bottom case including a bottom wall and a bottom outer wall extending from the bottom wall toward the bottom wall. The tape, which is a print medium, is wound and mounted within the housing. The printer head insertion portion is a space extending through the housing in a direction perpendicular to the bottom wall and having an oblong rectangular cross-sectional shape, the oblong rectangular shape extending parallel to the front wall. The arm portion includes a first wall portion and a second wall portion, and directs the tape along a feed path between the first wall portion and the second wall portion to an exit. The first wall portion is a section of the bottom outer wall. The second wall portion is disposed between the first wall portion and the printer head insertion portion, and extends perpendicularly upwards from the bottom wall. The first width direction regulating portion is provided on the second wall portion to restrict a movement of the tape in a tape width direction. The first print surface side regulating portion is provided on the second wall portion to restrict the movement of the tape toward a print surface side of the tape, bend the feed path of the tape toward the printer head insertion portion, and guide the tape to be discharged from the exit to the outside of the arm portion. The first lower joining portion is provided on an upper end of the first width regulating portion. The first upper joining portion is provided on the top case to join with the first lower joining portion at a position that corresponds to a position of the first lower joining portion when the top case and the bottom case are joined.

Exemplary embodiments of the present invention also provide a tape cassette that includes a housing, a tape, a printer head insertion portion, an arm portion, a guide portion, a width direction regulating portion, a print surface side regulating portion, a lower joining portion, and an upper joining portion. The housing includes a top case and a bottom case, the top case including a top wall, and the bottom case including a bottom wall and a bottom outer wall extending from the bottom wall toward the top wall. The tape, which is a print medium, is wound and mounted within the housing. The printer head insertion portion is a space extending through the housing in a direction perpendicular to the bottom wall and having an oblong rectangular cross-sectional shape, the oblong rectangular shape extending parallel to the front wall. The arm portion includes a first wall portion and a second wall portion, and directs the tape along a feed path between the first wall portion and the second wall portion to an exit. The first wall portion is a section of the bottom outer wall. The second wall portion is disposed between the first wall portion and the printer head insertion portion, and extends perpendicularly upwards from the bottom wall. The guide portion directs the tape discharged from the exit of the arm portion toward a downstream side in a feed direction of the tape. The width direction regulating portion is provided on the bottom case at a downstream side of the guide portion in the tape feed direction to restrict a movement of the tape in a tape width direction. The print surface side regulating portion is provided on the bottom case at a downstream side of the guide portion in the tape feed direction to restrict the movement of the tape toward a print surface side of the tape. The lower joining portion is provided on an upper end of the width direction regulating portion. The upper joining portion is provided on the top case to join with the lower joining portion at a position that corresponds to a position of the lower joining portion when the top case and the bottom case are joined.

Exemplary embodiments of the present invention further provide a tape cassette that includes a housing, a tape, a printer head insertion portion, an arm portion, a width direction regulating portion, a lower joining portion, and an upper joining portion. The housing includes a top case and a bottom case, the top case including a top wall, and the bottom case including a bottom wall and a bottom outer wall extending from the bottom wall toward the top wall. The tape, which is a print medium, is wound and mounted within the housing. The printer head insertion portion is a space extending through the housing in a direction perpendicular to the bottom wall and having an oblong rectangular cross-sectional shape, the oblong rectangular shape extending parallel to the front wall. The arm portion includes a first wall portion and a second wall portion, and directs the tape along a feed path between the first wall portion and the second wall portion to an exit. The first wall portion is a section of the bottom outer wall. The second wall portion is disposed between the first wall portion and the printer head insertion portion, and extends perpendicularly upwards from the bottom wall. The tape feed roller is rotatably disposed within the housing at a downstream side of the printer head insertion portion in a feed direction to draw out the tape. The width direction regulating portion is provided on the bottom case at a downstream side of the tape feed roller in the feed direction to restrict the movement of the tape in the tape width direction. The lower joining portion is provided on an upper end of the width direction regulating portion. The upper joining portion is provided on the top case to join with the lower joining portion at a position that corresponds to a position of the lower joining portion when the top case and the bottom case are joined.

### BRIEF DESCRIPTION OF THE DRAWINGS

Exemplary embodiments of the present invention will be described below in detail with reference to the accompanying drawings in which:

FIG. 1 is a perspective view of a tape printer 1 when a cassette cover 6 is closed;

FIG. 2 is a perspective view illustrating a tape cassette 30 and a cassette housing portion 8 according to a first embodiment;

FIG. 3 is a plan view of the cassette housing portion 8 with the tape cassette 30 according to the first embodiment installed, when a platen holder 12 is at a standby position;

FIG. 4 is a plan view of the cassette housing portion 8 with the tape cassette 30 installed, when the platen holder 12 is at a print position;

FIG. 5 is a plan view of a head holder 74;

FIG. 6 is a front view of the head holder 74;

FIG. 7 is a left side view of the head holder 74;

FIG. 8 is a cross sectional view taken along line I-I in FIG. 3 as seen in the direction of the arrows, the cross sectional view being rotated counterclockwise by 90 degrees;

FIG. 9 is an exploded perspective view showing the structure of an arm portion 34;

FIG. 10 is a side cross sectional view of a first regulating portion 81 and a corresponding portion of the top case 31A;

FIG. 11 is a perspective view of the tape cassette 30 according to the first embodiment, as seen from a bottom surface side;

FIG. 12 is a front cross sectional view of the tape cassette 30 showing a state where a tape drive shaft 100 is inserted in a tape feed roller 46;

FIG. 13 is an exploded perspective view showing the structure in the vicinity of support holes 64A and 64B;

FIG. 14 is a side cross sectional view of a second regulating portion 82 and a corresponding portion of the top case 31A;

FIG. 15 is a side cross sectional view of a third regulating portion 83 and a corresponding portion of the top case 31A;

FIG. 16 is a front view of the tape cassette 30 according to the first embodiment;

FIG. 17 is an explanatory view of the tape cassette 30 according to the first embodiment as seen from the front side, the tape cassette 30 being inserted in the head holder 74;

FIG. 18 is an explanatory view of the tape cassette 30 according to the first embodiment as seen from the left side, the tape cassette 30 being inserted in the head holder 74;

FIG. 19 is an explanatory view of another tape cassette 30 according to the first embodiment as seen from the front side, the tape cassette 30 being inserted in the head holder 74;

FIG. 20 is an explanatory view of the other tape cassette 30 according to the first embodiment as seen from the left side, the tape cassette 30 being inserted in the head holder 74;

FIG. 21 is a perspective view of a die 400;

FIG. 22 is a side cross sectional view of the first regulating portion 81 of a bottom case 31B, before the die 400 is pulled out;

FIG. 23 is a plan view of the bottom case 31B in the vicinity of the first regulating portion 81, before the die 400 is pulled out;

FIG. 24 is a perspective view of the bottom case 31B after the die 400 has been pulled out;

FIG. 25 is a plan view of the cassette housing portion 8 with the tape cassette 30 according to a second embodiment installed;

FIG. 26 is a perspective view illustrating the tape cassette 30 and the cassette housing portion 8 according to a third embodiment;

FIG. 27 is a plan view of the cassette housing portion 8 with the tape cassette 30 according to the third embodiment installed;

FIG. 28 is a perspective view of the tape cassette 30 according to the third embodiment, as seen from the bottom surface side;

FIG. 29 is an explanatory view of the tape cassette 30 according to the third embodiment as seen from the front side, the tape cassette 30 being inserted in the head holder 74;

FIG. 30 is a side cross sectional view of the first regulating portion 81 and a corresponding portion of the top case 31A according to a modified example;

FIG. 31 is a side cross sectional view of the first regulating portion 81 and a corresponding portion of the top case 31A according to another modified example; and

FIG. 32 is a side cross sectional view of the first regulating portion 81 and a corresponding portion of the top case 31A according to vet another modified example.

### DETAILED DESCRIPTION OF EXEMPLARY EMBODIMENTS

Exemplary embodiments of the present invention will be explained below with reference to the figures. The configurations of the apparatuses and the like shown in the drawings are merely exemplary and do not intend to limit the present invention.

### First Embodiment

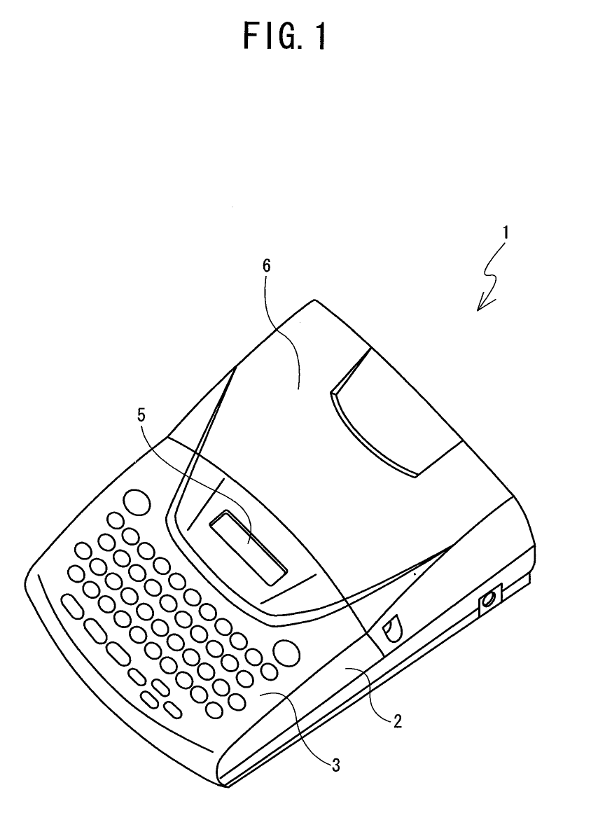

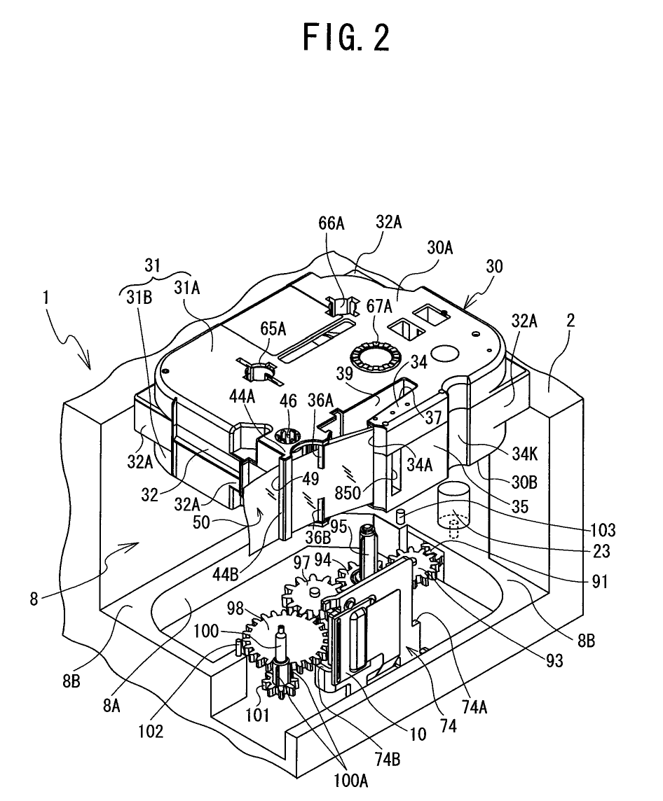

A tape printer 1 and a tape cassette 30 according to a first embodiment will be explained hereinafter with reference to FIG. 1 to FIG. 24. In the explanation of the present embodiment, the upper side, the lower side, the lower left side, the upper right side, the lower right side, and the upper left side in FIG. 1 are respectively defined as the upper side, the lower side, the front side, the rear side, the right side, and the left side of the tape printer 1. In addition, the upper side, the lower side, the lower right side, the upper left side, upper right side, and the lower left side in FIG. 2 are respectively defined as the upper side, the lower side, the front side, the rear side, the right side, and the left side of the tape cassette 30.

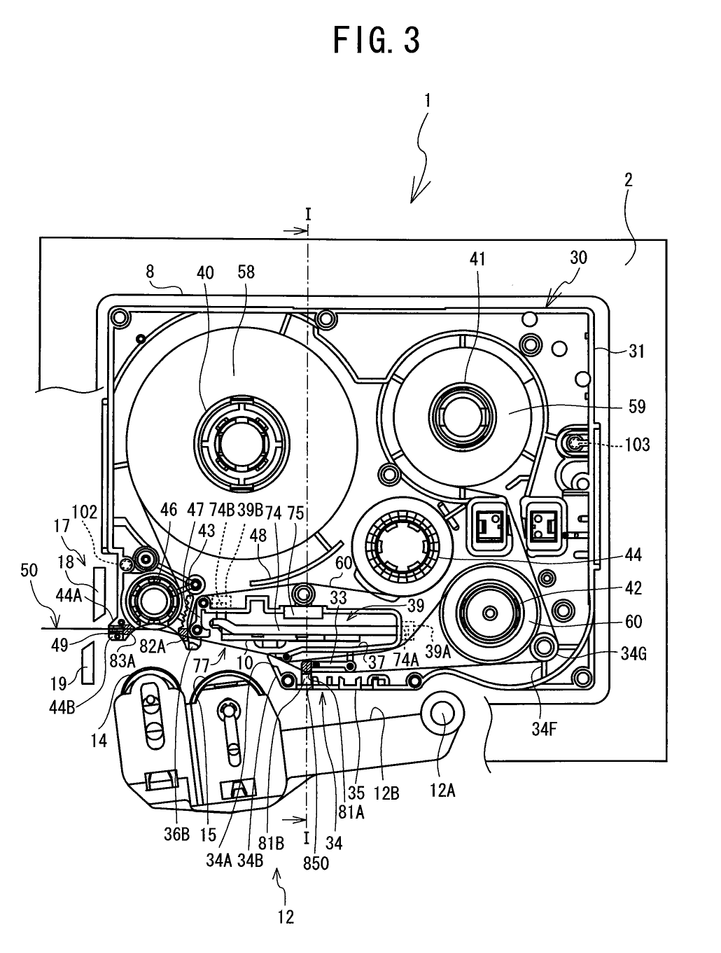

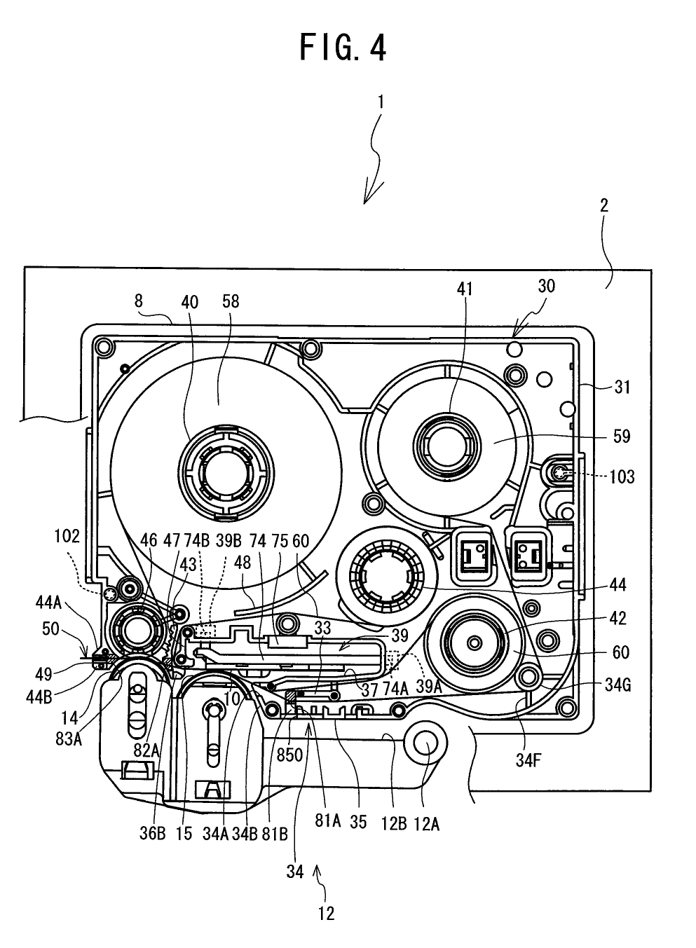

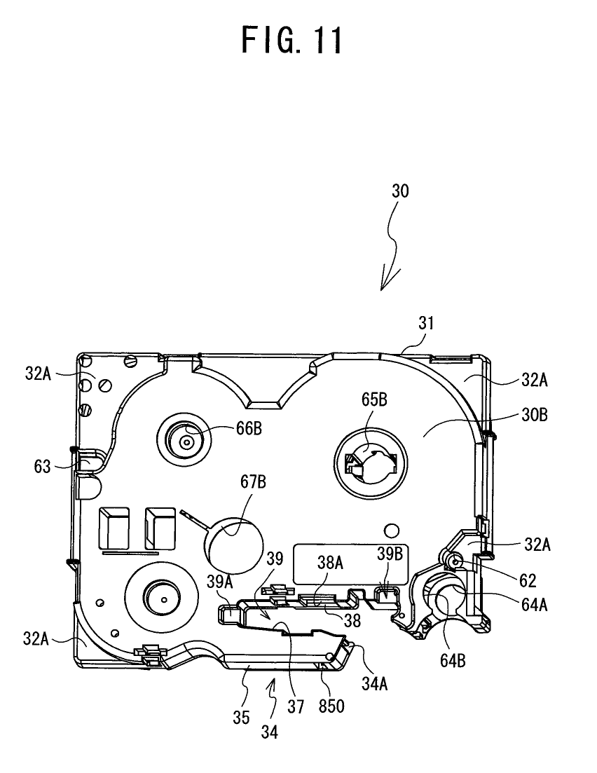

Note that, when walls that form the periphery of the cassette housing portion 8 are illustrated in FIG. 2 and FIG. 3 etc. used in the explanation below, these figures are simply schematic diagrams, and the walls shown in the figures are depicted as thicker than they are in actuality. In actuality, a group of gears, including gears 91, 93, 94, 97, 98 and 101 shown in FIG. 2 etc., is covered and hidden by a bottom surface of a cavity 8A. However, for explanatory purposes, the bottom surface of the cavity 8A is not shown in FIG. 2 etc. Further, FIG. 3 and FIG. 4 etc. show the tape cassette 30 that is installed in the cassette housing portion 8, with a top case 31A removed. Moreover, in the perspective views in FIG. 11 etc. that show the tape cassette 30 as seen from a bottom surface side, illustration of a tape feed roller 46 and the like is omitted for ease of explanation. These comments also apply to the figures that are used to explain other embodiments.

First, an outline configuration of the tape printer 1 according to the first embodiment will be explained. The tape printer 1 according to the first embodiment is a tape printer that produces a laminated tape having a laminated print surface. As shown in FIG. 1, the tape printer 1 is provided with a main unit cover 2 that has a rectangular shape in a plan view. A keyboard 3 is provided on the front side of the main unit cover 2. The keyboard 3 includes character keys for characters (letters, symbols, numerals, and so on), a variety of function keys, and so on. A display 5 is provided on the rear side of the keyboard 3. The display 5 displays input characters. A cassette cover 6 is provided on the rear side of the display 5. The cassette cover 6 may be opened and closed when the tape cassette 30 (refer to FIG. 2) is replaced. Further, although not shown in the figures, a discharge slit is provided to the rear of the left side of the main unit cover 2, from which the printed tape is fed out to the outside of the tape printer 1. Also, a discharge window is formed on the left side of the cassette cover 6, such that, when the cassette cover 6 is in a closed state, the discharge slit is exposed to the outside.

Next, an internal configuration within the main unit cover 2 below the cassette cover 6 will be explained with reference to FIG. 2 to FIG. 8. As shown in FIG. 2, the cassette housing portion 8 is provided in the interior of the main unit cover 2 below the cassette cover 6. The cassette housing portion 8 is an area in which the tape cassette 30 can be installed or removed. The cassette housing portion 8 includes the cavity 8A and a cassette support portion 8B. The cavity 8A is formed as a depression that has a flat bottom surface, and the shape of the cavity 8A generally corresponds to the shape of the bottom surface of a cassette case 31 (to be described later) when the tape cassette 30 is installed. The cassette support portion 8B is a flat portion extending horizontally from the outer edge of the cavity 8A. The shape of the cassette support portion 8B in a plan view generally corresponds to the shape of the tape cassette 30 in a plan view, that is, a rectangle that is longer in the left-right direction. The cassette support portion 8B is a portion that opposes the lower surface of corner portions 32A of the tape cassette 30 when the tape cassette 30 is installed in the cassette housing portion 8.

Two positioning pins 102 and 103 are provided at two positions on the cassette support portion 8B. More specifically, the positioning pin 102 is provided on the left side of the cavity 8A, and the positioning pin 103 is provided on the right side of the cavity 8A. The positioning pins 102 and 103 are provided at the positions that respectively oppose pin holes 62 and 63, when the tape cassette 30 is installed in the cassette housing portion 8. The pin holes 62 and 63 are two indentations formed in the lower surfaces of the corner portions 32A of the tape cassette 30 (refer to FIG. 11). When the tape cassette 30 is installed in the cassette housing portion 8, the positioning pins 102 and 103 are respectively inserted into the pin holes 62 and 63 to support the tape cassette 30 from underneath at the left and right positions of the peripheral portion of the tape cassette 30.

The cassette housing portion 8 is equipped with a feed mechanism, a print mechanism, and the like. The feed mechanism pulls out the tape from the tape cassette 30 and feeds the tape. The print mechanism prints characters on a surface of the tape. As shown in FIG. 2, a head holder 74 is fixed in the front part of the cassette housing portion 8, and a thermal head 10 that includes a heating element (not shown in the figures) is mounted on the head holder 74. A tape feed motor 23 that is a stepping motor is provided outside of the cassette housing portion 8 (the upper right side in FIG. 2). The drive gear 91 is anchored to the lower end of a drive shaft of the tape feed motor 23. The drive gear 91 is meshed with the gear 93 through an opening, and the gear 93 is meshed with the gear 94. A ribbon take-up shaft 95 is standing upward on the upper surface of the gear 94. The ribbon take-up shaft 95 drives the rotation of a ribbon take-up spool 44 (refer to FIG. 3), which will be described later.

In addition, the gear 94 is meshed with the gear 97, the gear 97 is meshed with the gear 98, and the gear 98 is meshed with the gear 101. A tape drive shaft 100 is standing upward on the upper surface of the gear 101. The tape drive shaft 100 drives the rotation of the tape feed roller 46, which will be described later. A tower section of a shaft body of the tape drive shaft 100 is provided with a plurality of cam members 100A that extend from the base end toward the leading end of the tape drive shaft 100. The plurality of cam members 100A is provided on the outer peripheral surface of the tape drive shaft 100 such that the cam members 100A extend radially in a plan view.

If the tape feed motor 23 is driven to rotate in the counterclockwise direction in a state where the tape cassette 30 is installed in the cassette housing portion 8, the ribbon take-up shaft 95 is driven to rotate in the counterclockwise direction via the drive gear 91, the gear 93 and the gear 94. The ribbon take-up shaft 95 causes the ribbon take-up spool 44, which is fitted with the ribbon take-up shaft 95, to rotate. Furthermore, the rotation of the gear 94 is transmitted to the tape drive shaft 100 via the gear 97, the gear 98 and the gear 101, to thereby drive the tape drive shaft 100 to rotate in the clockwise direction. The tape drive shaft 100 causes the tape feed roller 46, which is fitted with the tape drive shaft 100 by insertion, to rotate.

As shown in FIG. 3 and FIG. 4, on the front side of the head holder 74, an arm shaped platen holder 12 is pivotably supported around a support shaft 12A. A platen roller 15 and a movable feed roller 14 are both rotatably supported on the leading end of the platen holder 12. The platen roller 15 faces the thermal head 10, and may be moved close to and apart from the thermal head 10. The movable feed roller 14 faces the tape feed roller 46 that may be fitted with the tape drive shaft 100, and may be moved close to and apart from the tape feed roller 46.

A release lever (not shown in the figures), which moves in the left-right direction in response to the opening and closing of the cassette cover 6, is coupled to the platen holder 12. When the cassette cover 6 is opened, the release lever moves in the right direction, and the platen holder 12 moves toward the stand-by position shown in FIG. 3. Toward the stand-by position shown in FIG. 3, the platen holder 12 moves away from the cassette housing portion 8. Therefore, the tape cassette 30 can be installed into or detached from the cassette housing portion 8 when the platen holder 12 is at the stand-by position. The platen holder 12 is constantly elastically urged to remain in the stand-by position by a spiral spring that is not shown in the figures.

On the other hand, when the cassette cover 6 is closed, the release lever moves in the left direction and the platen holder 12 moves toward the print position shown in FIG. 4. Toward the print position shown in FIG. 4, the platen holder 12 moves closer to the cassette housing portion 8. When the tape cassette 30 is installed in the cassette housing portion 8, the platen roller 15 presses the thermal head 10 via a film tape 59 and an ink ribbon 60. At the same time, the movable feed roller 14 presses the tape feed roller 46 via a double-sided adhesive tape 58 and the film tape 59. Thus, at the print position shown in FIG. 4, printing can be performed using the tape cassette 30 installed in the cassette housing portion 8. The double-sided adhesive tape 58, the film tape 59 and the ink ribbon 60 will be explained in more detail later.

As shown in FIG. 3, a feed path along which a printed tape 50 is fed extends from a tape discharge aperture 49 of the tape cassette 30 to the discharge slit (not shown in the figures) of the tape printer 1. A cutting mechanism 17 that cuts the printed tape 50 at a predetermined position is provided on the feed path. The cutting mechanism 17 includes a fixed blade 18 and a movable blade 19 that opposes the fixed blade 18 and that is supported such that it can move in the back-and-forth direction (in the up-and-down direction in FIG. 3). The movable blade 19 is moved in the back-and-forth direction by a cutter motor that is not shown in the figures.

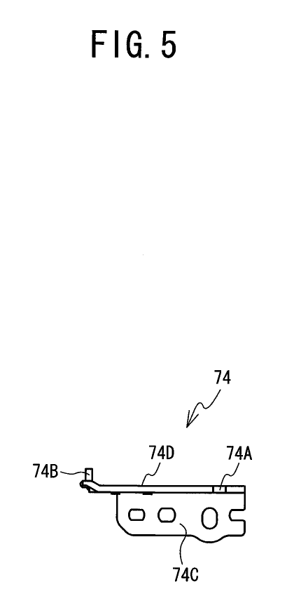

With reference to FIG. 3 and FIG. 5 to FIG. 7, the structure of the head holder 74 will be explained in detail. As shown in FIG. 5 to FIG. 7, the head holder 74 is formed from a plate-shaped member, and includes a seat portion 74C and a head fixing portion 74D. The seat portion 74C is fixed below the bottom surface (not shown in the figures) of the cavity 8A. The head fixing portion 74D is bent at generally a right angle from the seat portion 74C, and extends upward. The head fixing portion 74D is arranged along the left-right direction of the tape printer 1. The head holder 74 is arranged in the cassette housing portion 8 such that the head holder 74 opposes a head insertion portion 39 when the tape cassette 30 is installed. The head insertion portion 39 will be described later. Note that, the right end of the head holder 74 extends further to the right than the right end of the head insertion portion 39. As shown in FIG. 2, the thermal head 10 is firmly fixed on a front surface of the head fixing portion 74D.

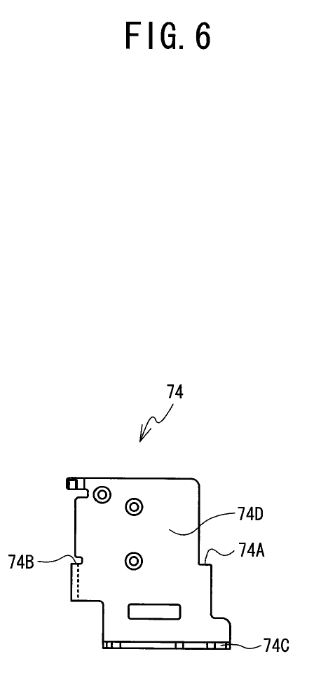

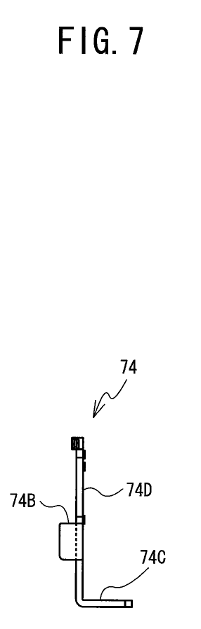

The head fixing portion 74D is provided with an upstream support portion 74A and a downstream support portion 74B (hereinafter collectively referred to as head support portions 74A and 74B) that support the tape cassette 30 from underneath when the tape cassette 30 is installed in the tape printer 1. As shown in FIG. 6, the upstream support portion 74A is a stepped portion that is formed at a predetermined height position by cutting the right edge of the head fixing portion 74D in an L-shape in a front view. As shown in FIG. 5 and FIG. 7, the downstream support portion 74B is an extending piece that has a rectangular shape in a side view and that extends at the predetermined height position from the left edge of the head fixing portion 74D at generally right angles with respect to the head fixing portion 74D.

In other words, the upstream support portion 74A and the downstream support portion 74B extend in directions perpendicular to each other in a plan view. The upstream support portion 74A and the downstream support portion 74B respectively support the tape cassette 30 on the upstream side and the downstream side of the thermal head 10 in a tape feed direction. The support of the tape cassette 30 by the head support portions 74A and 74B will be described later in detail.

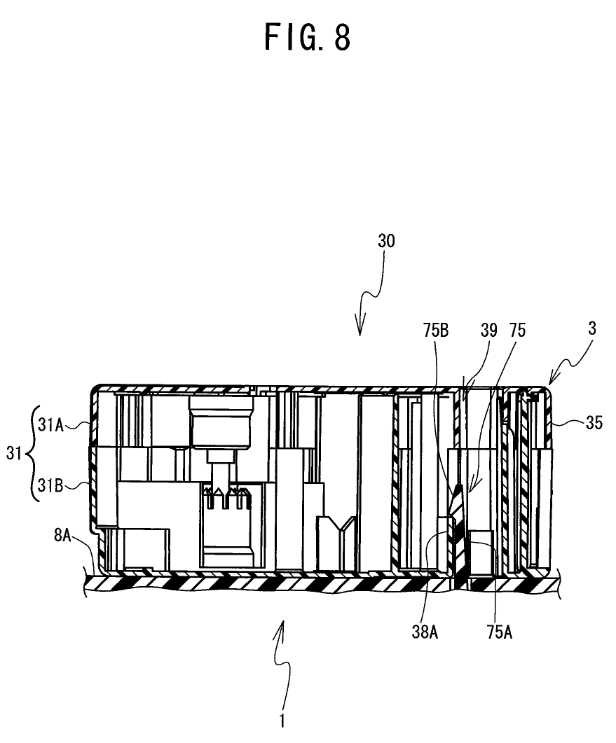

As shown in FIG. 3 and FIG. 4, a cassette hook 75 is provided on the rear side of the head holder 74. The cassette hook 75 will be explained in detail with reference to FIG. 8. Note that FIG. 8 is a cross sectional view taken along line I-I in FIG. 3 as seen in the direction of the arrows. The cross sectional view is rotated counterclockwise by 90 degrees for ease of understanding. The cassette hook 75 includes a plate-shaped protruding portion 75A that protrudes upward from the bottom surface (not shown in the figures) of the cavity 8A, at generally a right angle to the bottom surface. The top end of the protruding portion 75A is a claw portion 75B that has a generally triangular shape in a vertical sectional and protrudes rearward (in the left direction in FIG. 8). The protruding portion 75A is flexible in the front-rear direction (the left-right direction in FIG. 8) of the tape printer 1. The claw portion 75B is formed to correspond with the height position of a latch portion 38 (refer to FIG. 11) of the tape cassette 30 from the bottom surface. When the tape cassette 30 is installed in the cassette housing portion 8, the latch portion 38 engages with the cassette hook 75. This feature will be described later in detail.

Next, the configuration of the tape cassette 30 according to the first embodiment will be explained with reference to FIG. 2 to FIG. 4 and FIG. 8 to FIG. 15. The tape cassette 30 according to the first embodiment is a tape cassette used to produce a laminated tape. As shown in FIG. 2, the tape cassette 30 includes the cassette case 31 that is a housing having a generally rectangular parallelepiped shape (box-like shape), with rounded corner portions. The cassette case 31 includes a bottom case 31B that includes a bottom wall 30B, and the top case 31A that includes a top wall 30A. The top case 31A is pressed and fitted to an upper portion of the bottom case 31B. In the explanation below, a distance from the bottom surface to the top surface is referred to as a height of the tape cassette 30 or a height of the cassette case 31.

The cassette case 31 has the corner portions 32A that have the same width (the same length in the vertical direction), regardless of the type of the tape cassette 30. The corner portions 32A each protrude in an outward direction to form a right angle when seen in a plan view. However, the front left corner portion 32A does not form a right angle in the plan view, as the tape discharge aperture 49 is provided in the corner. When the tape cassette 30 is installed in the cassette housing portion 8, the lower surface of the corner portions 32A opposes the above-described cassette support portion 8B inside the cassette housing portion 8.

The cassette case 31 includes a portion that is called a common portion 32. The common portion 32 includes the corner portions 32A and encircles the cassette case 31 along the side surface at the same position as the corner portions 32A in the vertical (height) direction of the cassette case 31 and also has the same width as the corner portions 32A. More specifically, the common portion 32 is a portion that has a symmetrical shape in the vertical direction with respect to a center line in the vertical (height) direction of the cassette case 31. The height of the tape cassette 30 differs depending on a tape width of the mounted film tape 59 and the double-sided adhesive tape 58 (namely, the printed tape 50). However, a width (a length in the vertical direction) T of the common portion 32 is set to have the same dimension, regardless of the tape width of the printed tape 50.

For example, when the width T of the common portion 32 is 12 mm, as the tape width of the printed tape 50 is larger (18 mm, 24 mm, 36 mm, for example), the height of the cassette case 31 becomes accordingly larger, but the width T of the common portion 32 remains constant. If the tape width of the printed tape 50 is equal to or less than the width T of the common portion 32 (6 mm, 12 mm, for example), the height (the width) of the cassette case 31 is the width T of the common portion 32 (12 mm) plus a predetermined width. The height of the cassette case 31 is at its smallest in this case.

As shown in FIG. 2, the top case 31A and the bottom case 31B respectively have support holes 65A, 66A and 67A and support holes 65B, 66B and 67B (refer to FIG. 11) that rotatably support a first tape spool 40, a second tape spool 41 and the ribbon take-up spool 44, which will be explained later. As shown in FIG. 3 and FIG. 4, the double-sided adhesive tape 58 wound on the first tape spool 40, the transparent film tape 59 wound on the second tape spool 41, and the ink ribbon 60 wound on a ribbon spool 42 are mounted in the cassette case 31. The double-sided adhesive tape 58 is a double-sided tape having a surface to which a release paper is affixed. The double-sided adhesive tape 58 is affixed to the print surface of the printed film tape 59.

The first tape spool 40, on which the double-sided adhesive tape 58 is wound with its release paper facing outward, is rotatably supported by the support holes 65A and 65B on the rear left side within the cassette case 31. The second tape spool 41, on which the film tape 59 is wound, is rotatably supported by the support holes 66A and 66B on the rear right side within the cassette case 31. Further, the ink ribbon 60 that is wound on the ribbon spool 42 is rotatably arranged on the front right side within the cassette case 31.

Between the first tape spool 40 and the ribbon spool 42 in the cassette case 31, the ribbon take-up spool 44 is rotatably supported by the support holes 67A and 67B. The ribbon take-up spool 44 pulls out the ink ribbon 60 from the ribbon spool 42 and takes up the ink ribbon 60 that has been used to print the characters. A clutch spring (not shown in the figures) is attached to a lower portion of the ribbon take-up spool 44 to prevent loosening of the taken up ink ribbon 60 due to a reverse rotation of the ribbon take-up spool 44.

As shown in FIG. 2, a semi-circular groove 34K that has a semi-circular shape in a plan view is provided in a front wall of the cassette ease 31, and extends over the height of the cassette case 31 (in other words, extends from the top surface to the bottom surface). The semi-circular groove 34K is a recess that serves to prevent an interference between the shaft support 12A and the cassette case 31 when the tape cassette 30 is installed in the cassette housing portion 8. The shaft support 12A is the center of rotation of the platen holder 12. Of the front wall of the cassette case 31, a section that stretches leftwards from the semi-circular groove 34K is referred to as the arm front wall 35. A portion that is defined by the arm front wall 35 and an arm rear wall 37 and that extends leftwards from the right side of the tape cassette 30 is referred to as an arm portion 34. The arm rear wall 37 is a wall separately provided at the rear of the arm front wall 35, and extends over the height of the cassette case 31. A die exit hole 850 is provided in the arm front wall 35 in the vicinity of its left end. The die exit hole 850 is a through-hole having a vertically long rectangular shape. The die exit hole 850 will be described later in detail.

As shown in FIG. 3 and FIG. 4, a separating wall 33 (to be described later) is provided between the arm front wall 35 and the arm rear wall 37. Further, a guide pin 34G is provided on the upstream side (the right side in FIG. 3 and FIG. 4) of the front right portion of the bottom case 31B. A regulating piece 34F is provided at the lower end of the guide pin 34G. The regulating piece 34F is formed at the same height position as a first lower regulating portion 81B of a first regulating portion 81 that will be described later. The film tape 59 that has been pulled out from the second tape spool 41 is folded back in the left direction by the guide pin 34G, and is directed between the arm front wall 35 and the separating wall 33.

The ink ribbon 60 that has been pulled out from the ribbon spool 42 is directed between the arm rear wall 37 and the separating wall 33. The leading end of the arm front wall 35 is an inclined portion 34B that is bent rearward. An exit 34A is formed by the leading ends of the inclined portion 34B and the arm rear wall 37. The film tape 59 and the ink ribbon 60 are joined together at the exit 34A and discharged therefrom toward an opening 77 that will be described later.

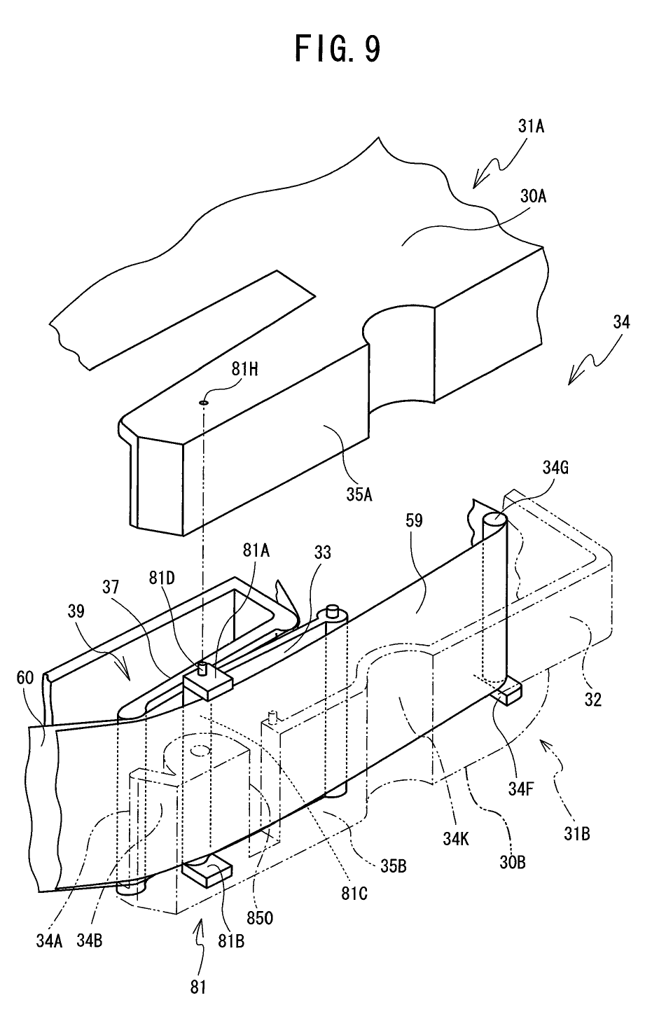

Here, the structure of the arm portion 34 will be explained in detail with reference to FIG. 9. As described above, the cassette case 31 is formed by joining the top case 31A and the bottom case 31B. Hereinafter, of the front wall of the top case 31A, a section that corresponds to the arm front wall 35 of the cassette case 31 is referred to as an arm upper front wall 35A. Of the front wall of the bottom case 31B, a section that corresponds to the arm front wall 35 of the cassette case 31 is referred to as an arm lower front wall 35B.

As shown in FIG. 9, sections that form the arm portion 34 in the bottom case 31B include the arm lower front wall 35B, the separating wall 33 and the arm rear wall 37. The separating wall 33 is a wall separately provided at the rear of the arm lower front wall 35B, and extends upward from the bottom wall 30B. The arm rear wall 37 is a wall separately provided at the rear of the separating wall 33, and extends upward from the bottom wall 30B to define the head insertion portion 39 that will be described later. The heights of the arm rear wall 37 and the separating wall 33 from the bottom wall 30B are generally the same, and are generally the same as a ribbon width of the ink ribbon 60. On the other hand, the arm lower front wall 35B is lower than the arm rear wall 37 and the separating wall 33.

The left end of the arm lower front wall 35B has the inclined portion 34B that is inclined rearward. The exit 34A of the arm portion 34 is formed by the inclined portion 34B and the left end of the arm rear wall 37. Further, the die exit hole 850 is formed in the arm lower front wall 35B on the near right side of the inclined portion 34B. The die exit hole 850 is formed by cutting out an upper portion of the arm lower front wall 35B in a vertically long rectangular shape in a front view. When the top case 31A is joined to the bottom case 31B, a through-hole is formed in the arm front wall 35 (refer to FIG. 2). The die exit hole 850 is located at a position that faces the first regulating portion 81 of the separating wall 33 that will be described later. The die exit hole 850 is an exit hole of a die that is necessary to form the first regulating portion 81.

The arm rear wall 37 has smooth bulges on the front side at the right end that is connected to a right peripheral wall of the head insertion portion 39, and at the left end that is adjacent to the exit 34A. The bulges extend over the height of the arm rear wall 37. The center of the bulge in the left-right direction slightly protrudes forward over the height of the bulge.

The separating wall 33 extends generally in parallel with the arm lower front wall 35B. The length of the separating wall 33 in the left-right direction is shorter than the arm lower front wall 35B. The left end of the separating wall 33 is located on the right side of the inclined portion 34B of the arm lower front wall 35B. The left end portion of the separating wall 33 protrudes upward as compared to other portions. The upwardly protruding portion has a plate-shaped protrusion that protrudes forward from the separating wall 33 and that has a generally rectangular shape in a plan view. In addition, the lower end of the separating wall 33 of the left end portion also has a protrusion that is formed on the bottom wall 30B and that protrudes forward at generally a right angle from the wall surface of the separating wall 33. This protrusion has a rectangular shape in a plan view. Hereinafter, these protrusions provided at the left end portion of the separating wall 33 are respectively referred to as a first upper regulating portion 81A and a first lower regulating portion 81B. Further, hereinafter, the first upper regulating portion 81A and the first lower regulating portion 81B are collectively referred to as first width direction regulating portions 81A and 81B. The first width direction regulating portions 81A and 81B are portions that restrict, in the arm portion 34, the movement of the film tape 59 in a tape width direction.

The right end portion of the separating wall 33 is formed in a cylindrical shape. The front side of the left end portion (the arm lower front wall 35B side) of the separating wall 33 has a smooth bulge extending in the vertical direction between the first width direction regulating portions 81A and 81B. The center in the left-right direction of the bulge slightly protrudes forward over the height of the bulge. Hereinafter, the bulge formed on the left end portion of the separating wall 33 is referred to as a first print surface side regulating portion 81C. The first print surface side regulating portion 81C is a portion that restricts, in the arm portion 34, the movement of the film tape 59 toward a side of a print surface (more specifically, to a side of the surface facing the print head, that is, the rear of the cassette case 31).

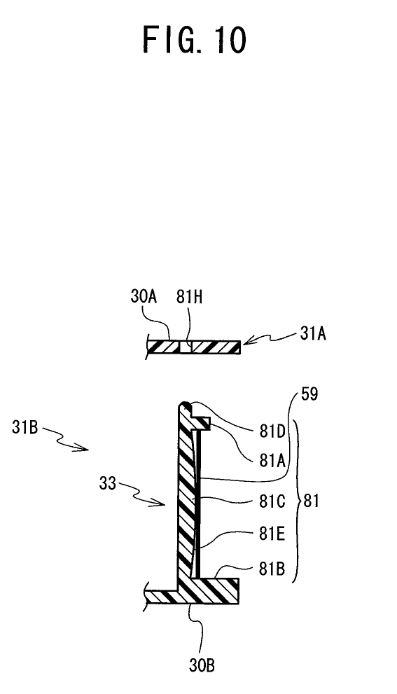

The structure of the left end portion of the separating wall 33 will be explained below in more detail, with reference to FIG. 10. As shown in FIG. 10, a protruding length of the first lower regulating portion 81B from the separating wall 33 is larger than a protruding length of the first upper regulating portion 81A from the separating wall 33. The first lower regulating portion 81B has the protruding length that extends as far as the arm lower front wall 35B (refer to FIG. 9). Note that, in actuality, the separating wall 33, the bottom wall 30B and the arm lower front wall 35B are integrally molded. Therefore, the first lower regulating portion 81B is contiguous with the lower end of the arm lower front wall 35B. Further, the first print surface side regulating portion 81C has a convex lens-like shape, and the central portion in the vertical direction slightly protrudes forward (to the right side in FIG. 10) in a vertical section. In other words, a regulating surface 81E of the first print surface side regulating portion 81C slightly protrudes at the central portion both in the left-right direction and in the vertical direction as compared to peripheral portions

Further, a protrusion 81D is provided on an upper portion of the first upper regulating portion 81A. On the other hand, the top wall 30A of the top case 31A is provided with a fitting hole 81H that penetrates the top wall 30A, at a position that corresponds to the protrusion 81D when the top case 31A is joined to the bottom case 31B. Therefore, when the top case 31A is joined to the bottom case 31B, the protrusion 81D is fitted into the fitting hole 81H, and the top case 31A and the bottom case 31B are thereby fixed. Hereinafter, the first width direction regulating portions 81A and 81B, the first print surface side regulating portion 81C and the protrusion 81D that are provided on the left end portion of the separating wall 33 are collectively referred to as the first regulating portion 81.

As shown in FIG. 3 and FIG. 4, a space that is surrounded by the arm rear wall 37 and a peripheral wall that extends continuously from the arm rear wall 37 is the head insertion portion 39. The head insertion portion 39 has a generally rectangular shape in a plan view and extends through the tape cassette 30 in the vertical direction. The head insertion portion 39 is connected to the outside also at the front side of the tape cassette 30, through the opening 77 provided on the front side of the tape cassette 30. The head holder 74 that supports the thermal head 10 of the tape printer 1 may be inserted into the head insertion portion 39. At the opening 77, the thermal head 10 performs printing on the film tape 59 that has been discharged from the exit 34A of the arm portion 34.

Support reception portions are provided at positions facing the head insertion portion 39 of the cassette case 31. The support reception portions are used to determine the position of the tape cassette 30 in the vertical direction when the tape cassette 30 is installed in the tape printer 1. In the first embodiment, an upstream reception portion 39A is provided on the upstream side of an insertion position of the thermal head 10 (more specifically, the print position) in the feed direction of the film tape 59 that is the print medium. In addition, a downstream reception portion 39B is provided on the downstream side. The upstream and the downstream reception portions 39A and 39B are hereinafter collectively referred to as the head reception portions 39A and 39B. When the tape cassette 30 is installed in the cassette housing portion 8, the head reception portions 39A and 39B respectively contact with the head support portions 74A and 74B provided on the head holder 74, and supported from underneath by the head support portions 74A and 74B.

Next, the structure of the head reception portions 39A and 39B will be described in detail with reference to FIG. 11. As shown in FIG. 11, both the head reception portions 39A and 39B are indented portions formed by indenting the bottom wall 30B of the cassette case 31 upwardly. The upstream reception portion 39A has a generally rectangular shape in a bottom view. The upstream reception portion 39A is indented from the head insertion portion 39 in a direction along the arm front wall 35. The downstream reception portion 39B also has a generally rectangular shape in a bottom view. The downstream reception portion 39B is indented from the head insertion portion 39 in a direction perpendicular to the arm front wall 35. In other words, the upstream reception portion 39A and the downstream reception portion 39B face the head insertion portion 39 in directions perpendicular to each other.

A distance between the height position of the head reception portions 39A and 39B and a vertical center position of the film tape 59 housed in the cassette case 31 is constant, regardless of the type of the tape cassette 30. More specifically, a distance between the height position of the ceiling surfaces of the respective indented portions and the vertical center position of the film tape 59 is constant. In other words, the distance remains constant even when the height of the tape cassette 30 is different. More specifically, the larger the width of the film tape 59 and the double-sided adhesive tape 58 mounted in the tape cassette 30, the deeper the depth of the head reception portions 39A and 39B that are indented portions provided in the bottom wall 30B. The support of the head reception portions 39A and 39B by the head support portions 74A and 74B will be described later in detail.

As shown in FIG. 11, the latch portion 38 is provided in the bottom case 31B at a position facing the head insertion portion 39, and at a position between the upstream reception portion 39A and the downstream reception portion 39B in the longitudinal direction of the head insertion portion 39. More specifically, the latch portion 38 is provided on a peripheral wall portion that opposes the arm rear wall 37, at a generally center position in the longitudinal direction of the head insertion portion 39. As shown in FIG. 8, a lower wall 38A of the latch portion 38 is extended to a position just below a contact position with the most protruding position of the claw portion 75B of the cassette hook 75 of the tape printer 1. Accordingly, when the tape cassette 30 is installed in the cassette housing portion 8, the cassette hook 75 engages with an upper edge of the lower wall 38A.

As shown in FIG. 11, the pin holes 62 and 63 are provided at two positions on the lower surface of the corner portions 32A, corresponding to the above-described positioning pins 102 and 103 of the tape printer 1. More specifically, the pin hole 62, into which the positioning pin 102 is inserted, is an indentation provided in the lower surface of the corner portion 32A to the rear of a support hole 64 (to be described later) that is provided in the front left portion of the cassette case 31 (the lower right side in FIG. 11). The pin hole 63, into which the positioning pin 103 is inserted, is an indentation provided in the lower surface of the corner portion 32A in the vicinity of a central portion of the right end of the cassette case 31 (the left side in FIG. 11). A distance between the height position of the pin holes 62 and 63 and a vertical center position of the film tape 59 housed in the cassette case 31 is constant, regardless of the type of the tape cassette 30. In other words, the distance remains constant even when the height of the tape cassette 30 is different.

As shown in FIG. 2, a pair of regulating members 36A and 36B are provided on the downstream side of the head insertion portion 39, in the feed direction of the film tape 59 from the exit 34A of the arm portion 34 to the tape discharge aperture 49. More specifically, the top case 31A is provided with the regulating member 36A, and the bottom case 31B is provided with the regulating member 36B, at a position that faces the regulating member 36A when the top case 31A is joined to the bottom case 31B. On the downstream side of the thermal head 10, the regulating members 36A and 36B restrict, in the vertical direction (the tape width direction). the film tape 59 which has been discharged from the exit 34A of the arm portion 34 and on which printing has been performed at the opening 77 by the thermal head 10. The regulating members 36A and 36B also direct the film tape 59 further to the downstream side in the feed direction.

As shown in FIG. 3 and FIG. 4, a guide wall 47 is standing from the bottom wall 30B in the vicinity of the rear side of the regulating member 36B, along the front-rear direction of the cassette case 31. The guide wall 47 is located on the left side of the head insertion portion 39. The guide wall 47 separates, from the film tape 59, the used ink ribbon 60 that has been discharged from the exit 34A of the arm portion 34 together with the film tape 59 and then used for printing at the opening 77 by the thermal head 10. Then, the guide wall 47 directs the used ink ribbon 60 toward the ribbon take-up spool 44. Thus, the printed film tape 59 and the ink ribbon 60 are separated at the guide wall 47. A partition wall 48 is standing between the guide wall 47 and the ribbon take-up spool 44. The partition wall 48 prevents mutual contact between the used ink ribbon 60 that is directed along the guide wall 47 and the double-sided adhesive tape 58 that is wound on and supported by the first tape spool 40.

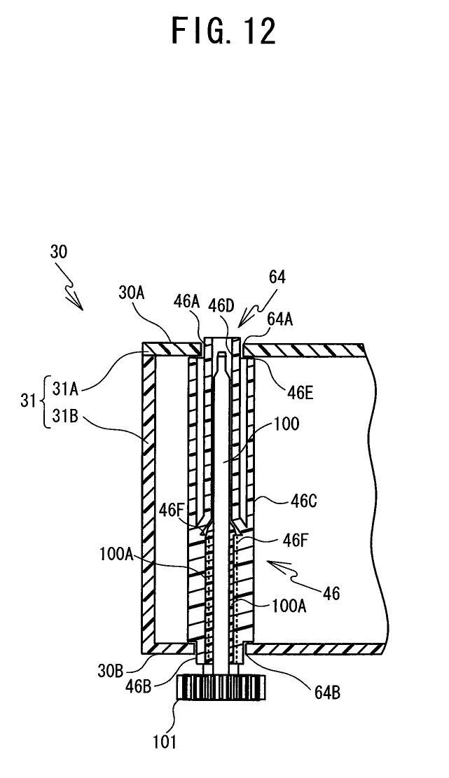

As shown in FIG. 11, the support holes 64A and 64B (refer to FIG. 11) are provided on the downstream side of the regulating members 36A and 36B and the guide wall 47 in the feed direction of the film tape 59. More specifically, the top case 31A is provided with the support hole 64A, and the bottom case 31B is provided with the support hole 64B. The tape feed roller 46 is rotatable and axially supported by the support holes 64A and 64B, sandwiched between the support holes 64A and 64B in the vertical direction. As shown in FIG. 12, The tape feed roller 46 pulls out the film tape 59 from the second tape spool 41, in concert with the opposing movable feed roller 14. At the same time, the tape feed roller 46 similarly pulls out the double-sided adhesive tape 58 from the first tape spool 40. Then, the tape feed roller 46 guides the double-sided adhesive tape 58 to the print surface of the film tape 59 to be affixed to the print surface, and feeds the printed tape 50 toward the discharge aperture 49.

Next, the structure of the tape feed roller 46 will be explained in detail with reference to FIG. 12. The tape feed roller 46 has a cylindrical shape, and has a height that is approximately the same as the height of the cassette case 31. A main body 46E of the tape feed roller 46 has a diameter larger than that of the support holes 64A and 64B. An outer peripheral surface of the main body 46E is a roller surface 46C that contacts with the film tape 59 and the double-sided adhesive tape 58. The length of the roller surface 46C in the vertical direction (namely, the tape feed width in the tape feed roller 46) is set to be the same as the tape width of the film tape 59 and the double-sided adhesive tape 58. An upper end 46A and a lower end 46B respectively protrude in the vertical direction from the main body 46E of the tape feed roller 46. The diameters of the upper end 46A and the lower end 46B are slightly smaller than the diameters of the support holes 64A and 64B, respectively. Inside the tape feed roller 46, an axial hole 46D that penetrates the main body 46E forms a connection between the upper end 46A and the lower end 46B.

Inside the cassette case 31, the upper end 46A is fitted into the support hole 64A provided in the top wall 30A of the top case 31A, and the lower end 46B is fitted into the support hole 64B provided in the bottom wall 30B of the bottom case 31B. The main body 46E contacts with the top wall 30A from underneath, and thereby restricts a movement of the tape feed roller 46 in the upward direction. Further, the main body 46E contacts with the bottom wall 30B from above, and thereby restricts the movement of the tape feed roller 46 in the downward direction. Thus, the tape feed roller 46 can rotate around its axis inside the cassette case 31, while it is supported by the upper end 46A and the lower end 46B.

Further, a plurality of engagement ribs 46F are provided on the lower end side of an inner peripheral surface (namely, an inner wall that defines the axial hole 46D) of the tape feed roller 46. The engagement ribs 46F have a shape that can be engaged with the plurality of cam members 100A (refer to FIG. 2) formed around the tape drive shaft 100.

As shown in FIG. 3 and FIG. 4, a partition wall 43 is standing between the tape feed roller 46 and the above-described guide wall 47. The partition wall 43 prevents mutual contact between the used ink ribbon 60 that is directed along the guide wall 47 toward the ribbon take-up spool 44, and the double-sided adhesive tape 58 that is directed along the tape feed roller 46 toward the film tape 59. The partition wall 43 is arranged along the support hole 64B that supports the tape feed roller 46, such that the partition wall 43 forms a gentle arc in the front-rear direction of the cassette case 31 in a plan view. A surface of the partition wall 43 on the support hole 64B (the tape feed roller 46) side is formed in a jagged shape in a plan view, in order to inhibit adhesion of the double-sided adhesive tape 58 that is being fed.

The tape discharge aperture 49 is provided on the downstream side of the tape feed roller 46 in the feed direction of the film tape 59. More specifically, the tape discharge aperture 49 is a gap formed between a tape discharge end 44A and a tape holder 44B. The tape discharge end 44A is a front end of a left side wall of the bottom case 31B. The tape holder 44B is a plate-shaped member provided in front of and separated from the tape discharge end 44A and that extends from the bottom wall 30B. The printed tape 50, namely, the printed film tape 59 to which the double-sided adhesive tape 58 has been affixed by the tape feed roller 46 and the movable feed roller 14, passes through the tape discharge aperture 49 and is fed toward the discharge slit (not shown in the figures) of the tape printer 1.

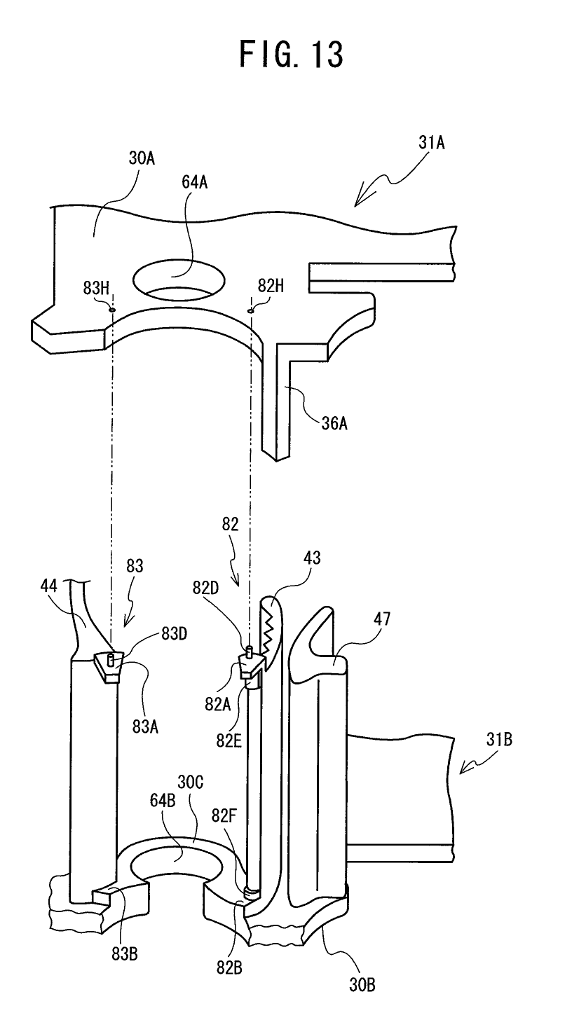

Next, with reference to FIG. 13 to FIG. 15, structures provided on the front end of the partition wall 43 and the tape discharge end 44A to restrict the movement of the film tape 59 will be described. Although FIG. 13 shows the structure of the top case 31A and the bottom case 31B in the vicinity of the support holes 64A and 64B that support the tape feed roller 46, in order to simplify the figure, the tape feed roller 46, the regulating member 36B and the tape holder 44B are not shown in FIG. 13.

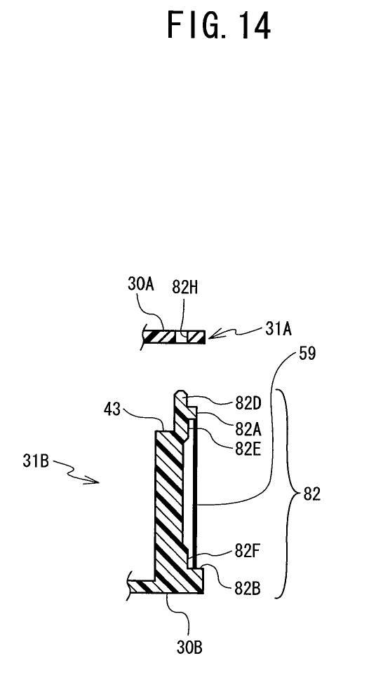

First, the structure provided on the front end of the partition wall 43 to restrict the movement of the film tape 59 in the tape width direction and the movement of the film tape 59 toward the print surface side will be explained with reference to FIG. 13 and FIG. 14. As shown in FIG. 13 and FIG. 14, the front end of the partition wall 43 protrudes upward as compared to other portions. The upwardly protruding portion is provided with a second upper regulating portion 82A that is a protruding piece that protrudes forward. The second upper regulating portion 82A is a plate-shaped member, and has a generally trapezoidal shape having a short side on the leading end side when viewed in a plan view. The height position of a lower surface of the second upper regulating portion 82A is the same as the height position of a lower surface of the first upper regulating portion 81A provided in the arm portion 34.

As shown in FIG. 13, the upper surface of the bottom wall 30B has a stepped portion 30C, which is formed around the support hole 64B such that it is one step higher than the other portions of the upper surface of the bottom wall 30B. The stepped portion 30C extends continuously to the right edge of the partition wall 43. Of the stepped portion 30C, a portion extending from the lower end of a front end surface of the partition wall 43 to the outer edge of the bottom case 31B is referred to as a second lower regulating portion 82B. The height position of an upper surface of the stepped portion 30C is the same as the height position of an upper surface of the first lower regulating portion 81B provided in the arm portion 34. Therefore, the height position of an upper surface of the second lower regulating portion 82B is also the same as that of the upper surface of the first lower regulating portion 81B. The second upper regulating portion 82A and the second lower regulating portion 82B are portions that restrict the movement in the tape width direction of the printed film tape 59 that has been separated from the ink ribbon 60. Hereinafter, the second upper regulating portion 82A and the second lower regulating portion 82B are collectively referred to as second width direction regulating portions 82A and 82B.

As shown in FIG. 13 and FIG. 14, the front end surface of the partition wall 43 includes a second upper print surface side regulating portion 82E and a second lower print surface side regulating portion 82F that are stepped portions that respectively protrude slightly forward. The second upper print surface side regulating portion 82E and the second lower print surface side regulating portion 82F are respectively provided on a lower portion of the second upper regulating portion 82A and an upper portion of the second lower regulating portion 82B. The second upper print surface side regulating portion 82E and the second lower print surface side regulating portion 82F are portions that restrict the movement of the printed film tape 59 toward the print surface side. Hereinafter, the second upper print surface side regulating portion 82E and the second lower print surface side regulating portion 82F are collectively referred to as second print surface side regulating portions 82E and 82F.

Further, a protrusion 82D is provided on an upper portion of the second upper regulating portion 82A. On the other hand, a fitting hole 82H that penetrates the top wall 30A is provided in the top wall 30A of the top case 31A, at a position that corresponds to the protrusion 82D when the top case 31A is joined to the bottom case 31B. Therefore, when the top case 31A is joined to the bottom case 31B, the protrusion 82D is fitted into the fitting hole 82H, thus fixing the top case 31A and the bottom case 31B together. Note that, hereinafter, the second width direction regulating portions 82A and 82B, the second print surface side regulating portions 82E and 82F, and the protrusion 82D that are provided on the front end of the partition wall 43 are collectively referred to as a second regulating portion 82.

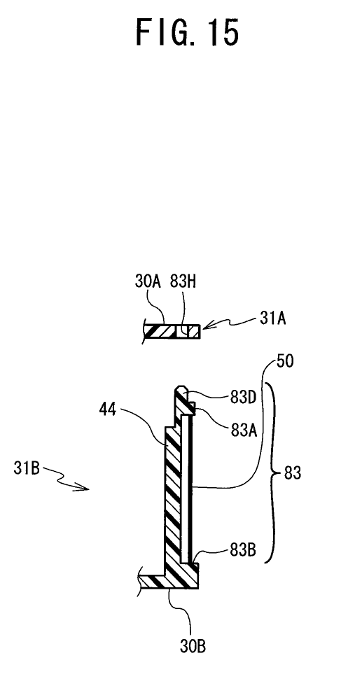

Next, the structure provided on the tape discharge end 44A to restrict the movement of the film tape 59 in the tape width direction will be explained with reference to FIG. 13 and FIG. 15. As shown in FIG. 13 and FIG. 15, the right side of the front end of the tape discharge end 44A protrudes upward as compared to other portions. The upwardly protruding portion is provided with a third upper regulating portion 83A that is a protruding piece that protrudes forward. The third upper regulating portion 83A is a plate-shaped member, and has a generally trapezoidal shape having a short side on the leading end side when viewed in a plan view. The height position of a lower surface of the third upper regulating portion 83A is the same as the height position of the lower surface of the first upper regulating portion 81A provided in the arm portion 34 and the lower surface of the second upper regulating portion 82A provided on the partition wall 43.

The above-described stepped portion 30C provided around the support hole 64B extends to below the third upper regulating portion 83A. Of the stepped portion 30C, a portion extending from the lower end of the front end surface of the tape discharge end 44A to the outer edge of the bottom case 31B is referred to as a third lower regulating portion 83B. Therefore, the height position of an upper surface of the third lower regulating portion 83B is the same as that of the upper surfaces of the first lower regulating portion 81B and the second lower regulating portion 82B. The third upper regulating portion 83A and the third lower regulating portion 83B restrict the movement of the printed tape 50 in the tape width direction, immediately before the printed tape 50 passes through the tape discharge aperture 49. Hereinafter, the third upper regulating portion 83A and the third lower regulating portion 83B are collectively referred to as third width direction regulating portions 83A and 83B.

Further, a protrusion 83D is provided on an upper portion of the third upper regulating portion 83A. On the other hand, a fitting hole 83H that penetrates the top wall 30A is provided in the top wall 30A of the top case 31A, at a position that corresponds to the protrusion 83D when the top case 31A is joined to the bottom case 31B. Therefore, when the top case 31A is joined to the bottom case 31B, the protrusion 83D is fitted into the fitting hole 83H, thereby fixing the top case 31A and the bottom case 31B together. Hereinafter, the third upper regulating portion 83A, the third lower regulating portion 83B, and the protrusion 83D that are provided on the tape discharge end 44A are collectively referred to as a third regulating portion 83.

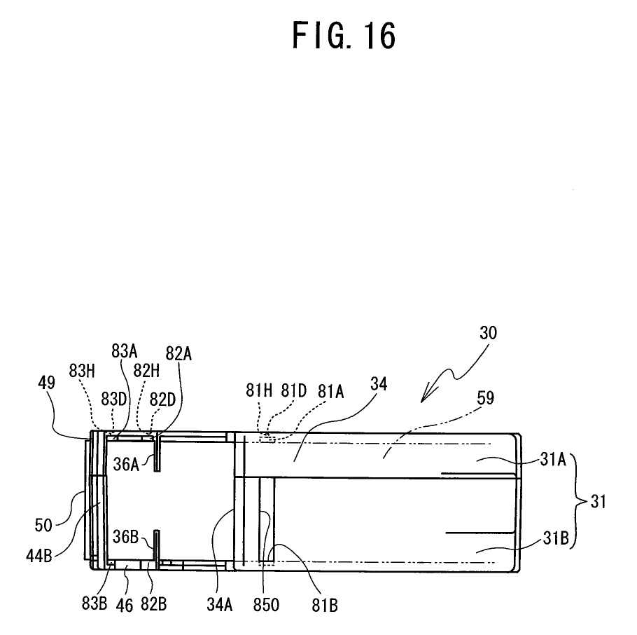

FIG. 16 is a front view of the tape cassette 30 that is formed by joining the top case 31A and the bottom case 31B configured as described above. As shown in FIG. 16, in the arm portion 34, the upper end and the lower end of the film tape 59 are sandwiched by the first upper regulating portion 81A and the first lower regulating portion 81B that are provided on the separating wall 33 (refer to FIG. 9) of the bottom case 31B. Thus, the movement of the film tape 59 in the tape width direction is restricted. Additionally, the protrusion 81D that protrudes from the first upper regulating portion 81A is fitted in the fitting hole 81H of the top case 31A so that the top case 31A and the bottom case 31B are securely fixed at this position.

Further, in the feed direction of the film tape 59, on the downstream side of the regulating members 36A and 36B that are respectively provided on the top case 31A and the bottom case 31B, the upper end and the lower end of the film tape 59 are sandwiched by the second upper regulating portion 82A and the second lower regulating portion 82B that are provided on the partition wall 43 (refer to FIG. 13) of the bottom case 31B. Thus, the movement of the film tape 59 in the tape width direction is restricted. Additionally, the protrusion 82D that protrudes from the second upper regulating portion 82A is fitted in the fitting hole 82H of the top case 31A so that the top case 31A and the bottom case 31B are securely fixed at this position.

Further, on the downstream side of the tape feed roller 46, and prior to the tape discharge aperture 49, the upper end and the lower end of the film tape 59 are sandwiched by the third upper regulating portion 83A and the third lower regulating portion 83B that are provided on the tape discharge end 44A (refer to FIG. 13) of the bottom case 31B. Thus, the movement of the film tape 59 in the tape width direction is restricted. Additionally, the protrusion 83D that protrudes from the third upper regulating portion 83A is fitted in the fitting hole 83H of the top case 31A so that the top case 31A and the bottom case 31B are securely fixed at this position.

Next, operations of the tape cassette 30 and the tape printer 1 when the tape cassette 30 of the first embodiment is installed in the tape printer 1 will be explained.

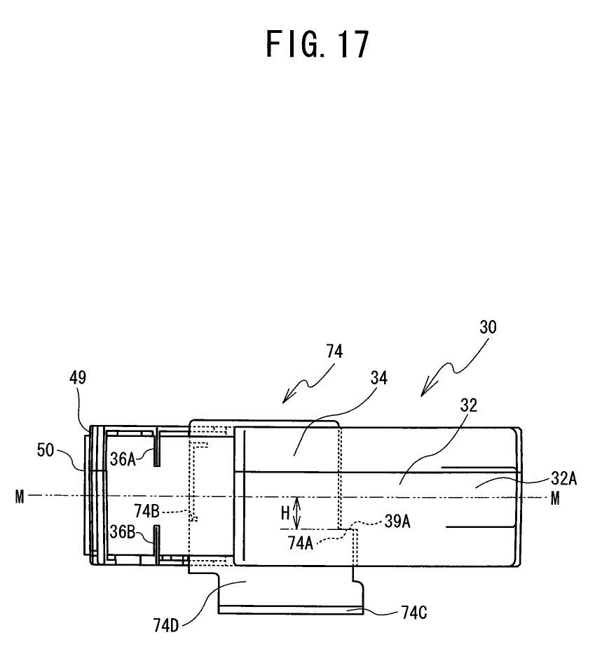

First, with reference to FIG. 2, FIG. 3, and FIG. 17 to FIG. 20, the support of the head reception portions 39A and 39B by the head support portions 74A and 74B will be explained. Note that the die exit hole 850 of the arm portion 34 is not shown in FIG. 17 to FIG. 20, in order to simplify the figures. When the tape cassette 30 is installed in the cassette housing portion 8, the tape cassette 30 is inserted vertically from above such that the bottom wall 30B of the tape cassette 30 opposes the bottom surface of the cavity 8A.

The head holder 74, the ribbon take-up shaft 95 and the tape drive shaft 100, which are shown in FIG. 2, protrude from the bottom surface (not shown in the figures) of the cavity 8A. A user therefore respectively inserts the above members into the head insertion portion 39, the ribbon take-up spool 44 and a shaft hole of the tape feed roller 46 to fit the tape cassette 30 into the cassette housing portion 8. As described above, the upstream support portion 74A and the downstream support portion 74B are respectively provided on the right end and the left end of the head holder 74. The upstream reception portion 39A and the downstream reception portion 39B are provided at positions on the tape cassette 30 that correspond to the positions of the upstream support portion 74A and the downstream support portion 74B. In other words, the upstream reception portion 39A and the downstream reception portion 39B are respectively provided at the positions on the right side and the left rear side of the head insertion portion 39 facing the head insertion portion 39.

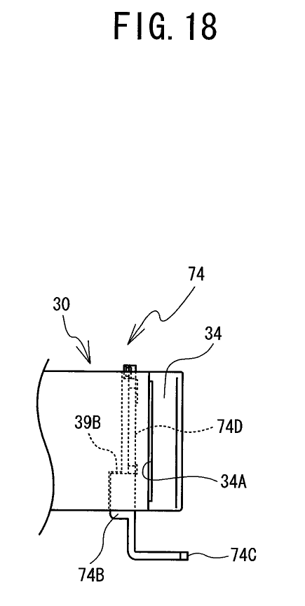

Therefore, when the user pushes the inserted tape cassette 30 downwards, as shown in FIG. 17, the upstream reception portion 39A of the tape cassette 30 comes into contact with the upstream support portion 74A provided on the head fixing portion 74D of the head holder 74. Then, the movement of the upstream reception portion 39A beyond that point in the downward direction is restricted. Further, as shown in FIG. 18, the downstream reception portion 39B of the tape cassette 30 comes into contact with the downstream support portion 74B provided on the head fixing portion 74D of the head holder 74. Then, the movement of the downstream reception portion 39B beyond that point in the downward direction is restricted. Then, the tape cassette 30 is held in a state in which the head reception portions 39A and 39B are respectively supported from underneath by the head support portions 74A and 74B.

In such a way, with the tape cassette 30 and the tape printer 1 according to the first embodiment, the positioning of the tape cassette 30 in the vertical direction may be accurately performed at a position in the vicinity of the thermal head 10 that performs printing on the film tape 59. Then, the center position of printing by the thermal head 10 in the vertical direction may be accurately matched with the center position of the film tape 59 in the tape width direction. In particular, in the feed direction of the film tape 59 as the print medium, the tape cassette 30 is supported on both the upstream and downstream sides with respect to the insertion position of the thermal head 10, more specifically, with respect to the print position. As a consequence, the positioning in the vertical direction may be particularly accurately performed. Thus, the center position of printing by the thermal head 10 in the vertical direction and the center position of the film tape 59 in the tape width direction may be particularly accurately matched with each other.

In addition, as shown in FIG. 3, the upstream reception portion 39A and the downstream reception portion 39B of the tape cassette 30 according to the first embodiment face the head insertion portion 39 in perpendicularly intersecting directions. Both the head reception portions 39A and 39B, which are indented portions in the bottom well 30B, are supported by the head support portions 74A and 74B that extend in the perpendicularly intersecting directions. Consequently, the movement of the tape cassette 30 is restricted not only in the vertical direction, but also in the left-right direction and the front-rear direction. As a result, a proper positional relationship can be maintained between the thermal head 10 and the head insertion portion 39.

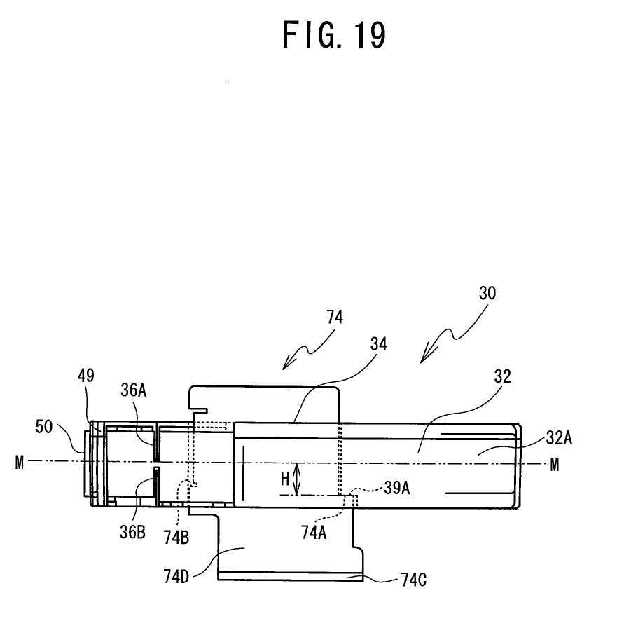

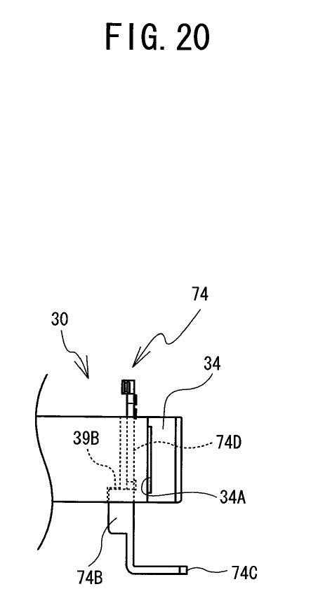

Also when the tape cassette 30 that has a lower height than the tape cassette 30 shown in FIG. 17 and FIG. 18 is installed in the cassette housing portion 8, the head reception portions 39A and 39B respectively come into contact with and are supported by the head support portions 74A and 74B, as shown in FIG. 19 and FIG. 20. In the tape cassette 30 shown in FIG. 19 and FIG. 20, the head reception portions 39A and 39B, which are indented portions provided in the bottom wall 30B, have a smaller depth than in the tape cassette 30 shown in FIG. 17 and FIG. 18. A distance H in the vertical (height) direction of the tape cassette 30 between the position of the head reception portions 39A and 39B, and a center position M in the vertical direction of the film tape 59 housed in the cassette case 31 is constant, regardless of the type of the tape cassette.

Thus, regardless of the type of the tape cassette 30, in other words, even when the height of the tape cassette 30 is different, the distance H is constant. Therefore, it is possible to use, in the same tape printer 1, a plurality of types of the tape cassette 30 with different heights. Further, by improving dimensional accuracy of the head reception portions 39A and 39B, it may be possible to efficiently control processing accuracy of the tape cassette 30. In addition, even when tapes with different widths are used, the tapes are fed at a position where the centers of the tapes in the tape width direction are matched. Therefore, it may be possible to inhibit the tapes from deviating, which may occur due to a difference in pressure applied to the tapes in the tape width direction when the centers of the tapes are not matched.

Next, the engagement of the tape cassette 30 with the cassette hook 75 will be explained with reference to FIG. 8. When the tape cassette 30 is inserted by the user into the cassette housing portion 8 and pushed downwards, the bottom wall 30B of the tape cassette 30 comes into contact with an upper portion of the claw portion 75B of the cassette hook 75. As shown in FIG. 8, the upper portion of the claw portion 75B inclines rearward (to the left side in FIG. 8). Therefore, when the user further pushes the tape cassette 30 downwards, the flexible protruding portion 75A bends forward (to the right side in FIG. 8) due to a pressing force from the bottom wall 30B.

If the user further pushes the tape cassette 30 downwards, the most protruding position of the claw portion 75B comes above the lower wall 38A of the latch portion 38. As a result, the protruding portion 75A returns to the original position again, and the claw portion 75B engages with the upper edge of the lower wall 38A. At this time, the tape cassette 30 is held by the head reception portions 39A and 39B. Because the cassette hook 75 engages with the latch portion 38 in this manner, after the tape cassette 30 is installed in the tape printer 1, any rising movement of the tape cassette 30, namely, a movement of the tape cassette 30 in the upward direction may be restricted, and tape feeding and printing can be stably performed.

Next, operations of the tape cassette 30 and the tape printer 1 when printing is performed after the tape cassette 30 according to the first embodiment has been installed in the tape printer 1 will be explained.

As described above, when the tape cassette 30 is installed at the correct position in the vertical direction in the cassette housing portion 8, the tape drive shaft 100 (refer to FIG. 2) is fittingly inserted into the tape feed roller 46, and the ribbon take-up shaft 95 (refer to FIG. 2) is fittingly inserted into the ribbon take-up spool 44. As described above, the plurality of engagement ribs 46F are provided on the lower end side of the inner peripheral surface (namely, the inner wall that defines the axial hole 46D) of the tape feed roller 46 (refer to FIG. 12). The engagement ribs 46F are meshed with the plurality of cam members 100A formed around the tape drive shaft 100.

After that, when the cassette cover 6 is closed, the platen holder 12 moves to the print position shown in FIG. 4, and the platen roller 15 faces the thermal head 10. At the same time, the movable feed roller 14 presses the tape feed roller 46. Thus, the tape printer 1 can perform printing on the film tape 59.

When printing is instructed by depressing a print key provided on the keyboard 3, the tape drive shaft 100 is driven to rotate. As shown in FIG. 12, the cam members 100A of the tape drive shaft 100 are meshed with the engagement ribs 46F provided on the tape feed roller 46. Therefore, rotation of the tape drive shaft 100 is transmitted to the tape feed roller 46. In other words, the tape feed roller 46 rotates along with the rotation of the tape drive shaft 100. The tape feed roller 46 pulls out the film tape 59 from the second tape spool 41 by moving in concert with the movable feed roller 14. Further, the ribbon take-up spool 44, which is driven to rotate via the ribbon take-up shaft 95, pulls out the unused ink ribbon 60 from the ribbon spool 42 in synchronization with the print speed.

As shown in FIG. 9, inside the arm portion 34, a ribbon feed path, along which the ink ribbon 60 is directed, is formed by the arm rear wall 37 and the separating wall 33. Further, a film tape feed path, along which the feed of the film tape 59 is directed, is formed by the arm front wall 35 and the separating wall 33. The ink ribbon 60 that has been pulled out from the ribbon spool 42 arranged on the rear right side of the arm portion 34 comes into contact with the bulge provided on the right end portion of the arm rear wall 37. As a result, the direction of the ink ribbon 60 is changed to the left, and the ink ribbon 60 is fed between the arm rear wall 37 and the separating wall 33. At this time, the ink ribbon 60 is restricted in the width direction by the lower surface of the top wall 30A of the top case 31A and the upper surface of the bottom wall 30B of the bottom case 31B. Then, the ink ribbon 60 is discharged from the exit 34A toward the opening 77, while the movement of the ink ribbon 60 toward the head insertion portion 39 side is restricted by the bulge provided on the left end portion of the arm rear wall 37.

The direction of the film tape 59, which has been pulled out from the second tape spool 41, is changed by the guide pin 34G while the lower end of the film tape 59 is restricted by the above-described regulating piece 34F of the guide pin 34G, and the film tape 59 is fed into the arm portion 34. Then, the film tape 59 is fed through the arm portion 34 while the movement of the film tape 59 in the tape width direction is restricted by the first upper regulating portion 81A and the first lower regulating portion 81B.

Further, while the film tape 59 is fed, the movement of the film tape 59 toward the print surface side is restricted by the cylindrical-shaped right end portion of the separating wall 33 and the first print surface side regulating portion 81C of the first regulating portion 81. The first print surface side regulating portion 81C has a smooth bulge extending over the height of the separating wall 33. Therefore, the film tape 59 is bent over the bulge toward the head insertion portion 39 side, is joined to the ink ribbon 60, and discharged from the exit 34A. Further, the central portion of the first print surface side regulating portion 81C in the vertical direction slightly protrudes forward (to the arm lower front wall 35B side). Therefore, the tension of the film tape 59 concentrates on the central portion in the tape width direction. As a result, the film tape 59 can be stably fed.

The first width direction regulating portions 81A and 81B and the first print surface side regulating portion 81C are formed on the bottom case 31B alone. Therefore, regardless of the fitting state of the top case 31A and the bottom case 31B, the dimensional accuracy of these members can be assured. Thus, it may be possible to appropriately restrict the movement of the film tape 59 in the tape width direction and the movement of the film tape 59 toward the print surface side, at a stage immediately before printing. Thus, the center position of printing by the thermal head 10 in the vertical direction and the center position of the film tape 59 in the tape width direction can be matched with each other particularly accurately. In addition, the first width direction regulating portions 81A and 81B and the first print surface side regulating portion 81C are provided on the separating wall 33 inside the arm portion 34 that is conventionally provided in the tape cassette 30. Therefore, space is not used wastefully.

As shown in FIG. 4, the film tape 59 that has been joined to the ink ribbon 60 and discharged from the arm portion 34 toward the opening 77 is fed between the thermal head 10 and the platen roller 15 of the tape printer 1. Meanwhile, the head reception portions 39A and 39B and the cassette hook 75 still function to maintain a stable installment state. Then, characters are printed onto the print surface of the film tape 59 by the thermal head 10 in a state in which the center position of printing by the thermal head 10 in the vertical direction and the center position of the film tape 59 in the tape width direction are matched with each other particularly accurately.

Following printing, while the film tape 59 is further directed to the downstream side by the regulating members 36A and 36B, the used ink ribbon 60 is separated from the printed film tape 59 at the guide wall 47 located behind the regulating members 36A and 36B, and wound onto the ribbon take-up spool 44. The printed film tape 59, which has passed between the regulating members 36A and 36B and separated from the ink ribbon 60, is fed while the movement in the tape width direction is restricted by the second upper regulating portion 82A and the second lower regulating portion 82B provided on the front end of the partition wall 43. Further, the front end surface of the partition wall 43 is provided with the second upper print surface side regulating portion 82E and the second lower print surface side regulating portion 82F (refer to FIG. 13). Therefore, the movement of the film tape 59 toward the print surface side is also restricted.

The second regulating portions 82A and 82B and the second print surface side regulating portions 82E and 82F are all formed in the bottom case 31B alone. Therefore, regardless of the fitting state of the top case 31A and the bottom case 31B, the movement of the film tape 59 that has been discharged from the arm portion 34 and then separated from the ink ribbon 60 can be appropriately restricted in the tape width direction and toward the print surface side. In addition, the second upper print surface side regulating portion 82E and the second lower print surface side regulating portion 82F are respectively provided only on the upper end and the lower end of the front end surface of the partition wall 43. Therefore, it may be possible to minimize the section that contacts with the printed portion of the film tape 59. Consequently, it may be possible to reduce the possibility of deterioration in print quality.

In the related art, because of the structure of the cassette case, an upper print surface side regulating portion is provided on the top case, and a lower print surface side regulating portion is provided on the bottom case. In this case, the upper print surface side regulating portion and the lower print surface side regulating portion are separate components. If the positions of the two print surface side regulating portions are misaligned, a line that connects the two print surface side regulating portions is not maintained at right angles with respect to the tape feed direction. As a result, a failure may occur in which the tape is not correctly fed in the tape feed direction. Contrary to this, according to the first embodiment, the two print surface side regulating portions (the second print surface side regulating portions 82E and 82F) are formed integrally with the bottom case 31B. Therefore, the line that connects the two print surface side regulating portions can be maintained at right angles with respect to the tape feed direction. As a result, the tape can be correctly directed in the tape feed direction.

The double-sided adhesive tape 58 is pulled out from the first tape spool 40 by the tape feed roller 46 moving in concert with the movable feed roller 14. While being guided and caught between the tape feed roller 46 and the movable feed roller 14, the double-sided adhesive tape 58 is layered onto and affixed to the print surface of the printed film tape 59. The printed film tape 59 to which the double-sided adhesive tape 58 has been affixed (namely, the printed tape 50) is then fed toward the tape discharge aperture 49.

The third upper regulating portion 83A and the third lower regulating portion 83B are provided on the tape discharge end 44A just prior to the tape discharge aperture 49 (refer to FIG. 13). Therefore, the printed tape 50 is discharged through the tape discharge aperture 49 while the movement of the printed tape 50 in the tape width direction is restricted by the third upper regulating portion 83A and the third lower regulating portion 83B. Then, the printed tape 50 is cut by the cutting mechanism 17. The third regulating portions 83A and 83B are formed on the bottom case 31B alone. Therefore, regardless of the fitting state of the top case 31A and the bottom case 31B, the movement of the printed tape 50 in the tape width direction can be appropriately restricted, at a position where a displacement of the printed tape 50 may occur in the tape width direction due to the drive of the tape feed roller 46.

As described above, the tape feed roller 46 includes, at its lower end, the engagement ribs 46F adapted to engage with the cam members 100A of the tape drive shaft 100. The tape feed roller 46 with this structure is driven to rotate in a lower portion in the tape width direction. Therefore, a component of force that pushes the tape feed roller 46 in the upward direction is generated, and thus the top case 31A may be likely to be pushed up particularly in the vicinity of the tape discharge aperture 49 located on the downstream side of the tape feed roller 46. Accordingly, if the third upper regulating portion 83A and the third lower regulating portion 83B are formed integrally with the bottom case 31B, the movement of the printed tape 50 in the tape width direction can be reliably restricted, at the position where a displacement of the printed tape 50 may occur in the tape width direction due to the drive of the tape feed roller 46.

In the related art, members that restrict the movement of the film tape 59, which is the print medium, in the tape width direction are provided on the top case and the bottom case, like the above-described regulating members 36A and 36B (refer to FIG. 2). In this case, the bottom case that is manufactured by resin molding can be manufactured by just using a die that is pulled out in an upward direction (in a direction perpendicular to the bottom wall) after molding. However, as in the first embodiment, when the regulating portions (the first width direction regulating portions 81A and 81B, the second width direction regulating portions 82A and 82B, and the third width direction regulating portions 83A and 83B), which restrict the movement of the film tape 59 in the tape width direction, are formed to protrude in the horizontal direction, the die cannot be pulled out in the upward direction around these protruded portions. Accordingly, a die that can be pulled out after molding in the lateral direction (in parallel with the bottom wall 30B) is needed for portions that correspond to these regulating portions.

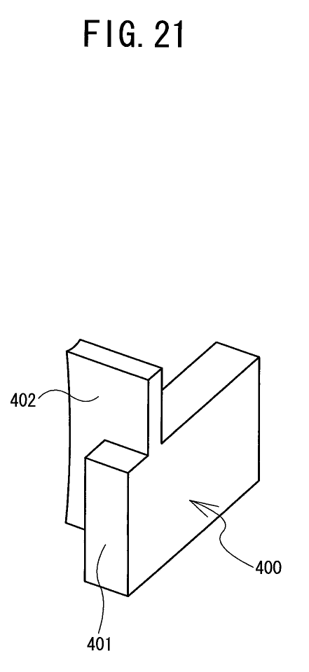

With reference to FIG. 21 to FIG. 24, a method for manufacturing the bottom case 31B of the tape cassette 30 according to the first embodiment using a die will be explained below, by using as an example of the first regulating portion 81 provided on the separating wall 33 of the arm portion 34. Note that the up-and-down direction in FIG. 21 is defined as the vertical direction of a die 400. The lower right direction, the upper left direction, the upper right direction and the lower left direction in FIG. 21 are respectively defined as the front side, the rear side, the right side and the left side of the die 400.

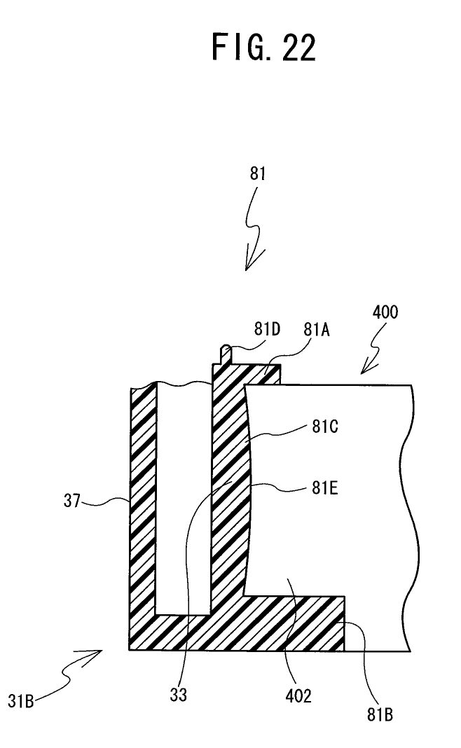

As shown in FIG. 21, the die 400 for molding the first regulating portion 81 includes a base portion 401 having a generally rectangular parallelepiped shape, and a protruding portion 402 that protrudes rearward and upward from the base portion 401. The base portion 401 has the same shape as the arm lower front wall 35B in a front view. As shown in FIG. 22, a lower end of the protruding portion 402 is located at the same height as the height, from the bottom surface of the bottom case 31B, of the first lower regulating portion 81B provided on the separating wall 33. Further, a length of the protruding portion 402 in the vertical direction is equal to a distance between the first upper regulating portion 81A and the first lower regulating portion 81B.

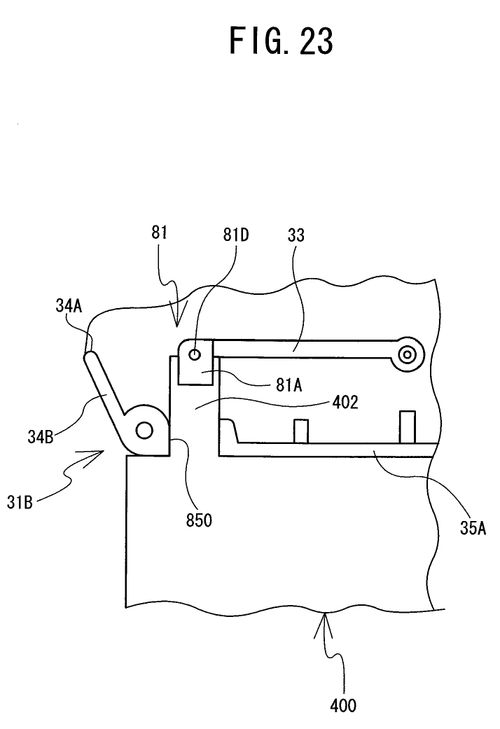

Further, a protruding length of the protruding portion 402 in the rearward direction from the base portion 401 is equal to a distance between the arm lower front wall 35B and the separating wall 33. Note that, as described above, the regulating surface 81E of the first print surface side regulating portion 81C slightly protrudes forward at the central portion as compared to peripheral portions, both in the left-right direction and in the vertical direction. Therefore, as shown in FIG. 21 and FIG. 22, in correspondence with the regulating surface 81E, a rear surface of the protruding portion 402 of the die 400 is slightly indented at its central portion as compared to peripheral portions both in the left-right direction and in the vertical direction. Further, as shown in FIG. 23, the length of the protruding portion 402 in the left-right direction is slightly larger than that of the first upper regulating portion 81A, and the same as that of the first lower regulating portion 81B that is not shown in FIG. 23. Note that, a die that is structured in the same manner and that can be pulled out in the lateral direction is also used for portions corresponding to the second and third regulating portions 82 and 83.

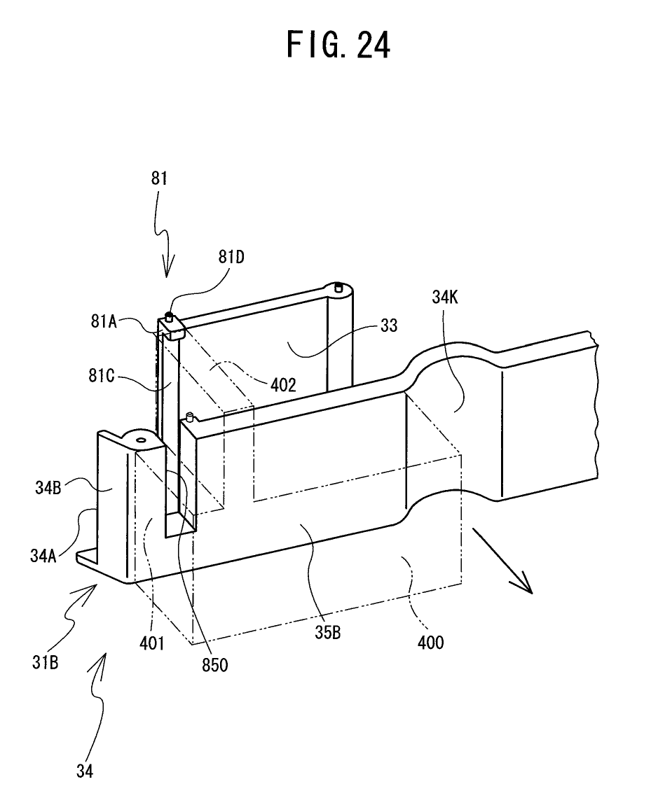

When the bottom case 31B is molded, the die 400 is set on an injection molding machine, together with a die corresponding to another portion, thereby forming a cavity that has the shape of the bottom case 31B. Then, resin is filled in the cavity and hardened to form the bottom case 31B. After that, as shown in FIG. 24, the die 400 used to form the first regulating portion 81 is pulled out in the lateral (forward) direction, and the other die is pulled out in the upward direction. The bottom case 31B is manufactured in this way. The die exit hole 850 is a hole that is formed at this time in the arm lower front wall 35B, in a section where the protruding portion 402 of the die 400 has been arranged during the resin molding.

Because the die that is pulled out in the lateral direction is used in this way, the regulating portions (the first width direction regulating portions 81A and 81B, the second width direction regulating portions 82A and 82B and the third width direction regulating portions 83A and 83B) that restrict the movement of the film tape 59 in the tape width direction can be formed in the bottom case 31B alone.

When the bottom case 31B is formed by using a die that is pulled out in the upward direction, an inclined section (a draft angle) is necessary for the section that extends upward with respect to the bottom wall 30B of the bottom case 31B, in order to enable the die to be smoothly pulled out. If such an inclined section is present, the film tape 59 may incline rearward or forward along the inclined section while it is being fed. Therefore, it may be difficult to feed the film tape 59 while maintaining a right angle to the bottom wall 30B. On the other hand, when the die that is pulled out in the lateral direction is used as described above, the inclined section for pulling out the die is not necessary. Therefore, it may be possible to feed the film tape 59 while maintaining a right angle with respect to the bottom wall 30B.

In addition, by using the die that is pulled out in the lateral direction, the first print surface side regulating portion 81C and the second print surface side regulating portions 82E and 82F can be formed in the bottom case 31B alone. The first print surface side regulating portion 81C has the regulating surface 81E whose central portion in the vertical direction slightly protrudes forward as compared to the peripheral portions. The second print surface side regulating portions 82E and 82F are stepped portions that are formed on the upper end and the lower end, respectively.

By providing the head reception portions 39A and 398, it is possible to improve accuracy of the print position of the film tape 59 that is fed while being appropriately restricted in the tape width direction by the first to third regulating portions 81 to 83. However, the tape cassette 30 according to the first embodiment may not be provided with the head reception portions 39A and 39B.

Further, the tape cassette 30 according to the first embodiment may not be provided with all of the first to third regulating portions 81 to 83. It may be possible to provide a regulating portion at a position where the film tape 59, which is the print medium, is desired to be restricted appropriately in the tape width direction. For example, only the first regulating portion 81 may be provided, only the second regulating portion 82 may be provided, or only the third regulating portion 83 may be provided. Alternatively, two regulating portions may be provided, such as the first regulating portion 81 and the second regulating portion 82, or the first regulating portion 81 and the third regulating portion 83.

Moreover, the regulating surface 81E of the first print surface side regulating portion 81C of the first regulating portion 81 may not be structured such that the central portion in the vertical direction protrudes forward as compared to the peripheral portions.

### Second Embodiment

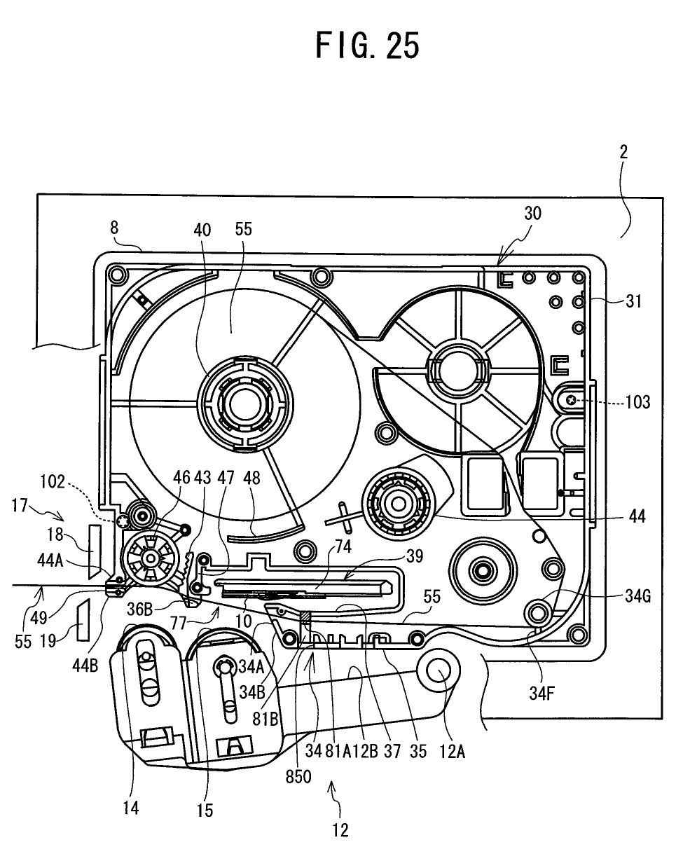

A second embodiment will be explained with reference to FIG. 25. In the first embodiment, an example is described in which the film tape 59 that is the print medium, the double-sided adhesive tape 58 that is to be affixed to the film tape 59, and the ink ribbon 60 that is used for printing are mounted in the tape cassette 30. Therefore, two feed paths for the film tape 59 and the ink ribbon 60 are provided in the arm portion 34. In the second embodiment, an example will be described in which, only a heat-sensitive paper tape 55 that is the print medium is mounted in the tape cassette 30, and in which only one feed path for the heat-sensitive paper tape 55 is provided in the arm portion 34.

Further, unlike the first embodiment, the tape cassette 30 according to the second embodiment is not provided with the head reception portions 39A and 39B (refer to FIG. 3) to be supported by the head support portions 74A and 74B of the head holder 74, and the latch portion 38 (refer to FIG. 11) to be engaged with the cassette hook 75. Hereinafter, the explanation focuses on structural elements that are different from those of the first embodiment, and explanation of structural elements that are the same or similar to those of the first embodiment may be omitted. In another embodiment that is to be described next, explanation of structural elements that are the same or similar to those that have already been explained may be omitted.

As shown in FIG. 25, in the tape cassette 30 according to the second embodiment, only the heat-sensitive paper tape 55 wound on the first tape spool 40 is rotatably supported by a support hole and mounted in the cassette case 31. The heat-sensitive paper tape 55 is a one-sided adhesive tape that has a surface to which a release paper is affixed. However, the heat-sensitive paper tape 55 need not be a one-sided adhesive tape. When the heat-sensitive paper tape 55 is used as a print medium, the ink ribbon 60 (refer to FIG. 3) is not necessary for printing by the thermal head 10. Further, in the second embodiment, the printed heat-sensitive paper tape 55 is not bonded to the double-sided adhesive tape 58 (refer to FIG. 3), and is discharged as it is. Therefore, the tape cassette 30 according to the second embodiment does not include the double-sided adhesive tape 58 and the ink ribbon 60 that are mounted in the tape cassette 30 according to the first embodiment.

In the first embodiment, as shown in FIG. 3 and FIG. 9, the separating wall 33 is provided in the arm portion 34. The feed path for the film tape 59 is formed between the arm front wall 35 and the separating wall 33, and the feed path for the ink ribbon 60 is formed between the arm rear wall 37 and the separating wall 33. In the second embodiment, as shown in FIG. 25, the separating wall 33 is not provided in the arm portion 34. Thus, the heat-sensitive paper tape 55 is fed between the arm front wall 35 and the arm rear wall 37, and is discharged from the exit 34A toward the opening 77.

In the second embodiment, the arm front wall 35 (more specifically, the arm lower front wall 35B) has the same structure as that of the first embodiment, and the die exit hole 850 is formed on the right side in the vicinity of the inclined portion 34B. However, unlike the first embodiment, the arm rear wall 37 of the second embodiment includes, at a position that faces the die exit hole 850, the first regulating portion 81 that is provided on the separating wall 33 in the first embodiment.

More specifically, the arm rear wall 37 according to the second embodiment includes the first upper regulating portion 81A that protrudes forward from the upper end of the arm rear wall 37, and the first lower regulating portion 81B that is formed on the bottom wall 30B and that protrudes forward from the lower end of the arm rear wall 37. Further, the arm rear wall 37 according to the second embodiment includes the first print surface side regulating portion 81C that has the regulating surface 81E whose central portion slightly protrudes forward as compared to peripheral portions, both in the left-right direction and in the vertical direction. Further, the protrusion 81D is provided on an upper portion of the first upper regulating portion 81A. On the other hand, the fitting hole 81H is provided in the top wall 30A of the top case 31A, at a position that corresponds to the protrusion 81D when the top case 31A is joined to the bottom case 31B. Details of these structural elements are the same as those shown in FIG. 10.

When printing is performed using the tape cassette 30 according to the second embodiment, the tape feed roller 46, which is driven to rotate via the tape drive shaft 100, pulls out the heat-sensitive paper tape 55 from the first tape spool 40 by moving in concert with the movable feed roller 14. The heat-sensitive paper tape 55 that has been pulled out from the first tape spool 40 has its direction changed to the left by the guide pin 34G provided on a front right portion of the cassette case 31, and is fed into the arm portion 34 while the lower end of the heat-sensitive paper tape 55 is restricted by the regulating piece 34F.

In the arm portion 34, the heat-sensitive paper tape 55 is fed while its movement in the tape width direction is restricted by the first upper regulating portion 81A and the first lower regulating portion 81B provided on the arm rear wall 37, and while its movement toward the print surface side is restricted by the first print surface side regulating portion 81C, in a similar way to the first regulating portion 81 of the first embodiment shown in FIG. 10. The first print surface side regulating portion 81C has a smooth bulge in the left-right direction. Therefore, the heat-sensitive paper tape 55 is bent toward the head insertion portion 39 side, and discharged from the exit 34A. Further, the first print surface side regulating portion 81C slightly protrudes forward at the central portion in the vertical direction. Therefore, the tension of the heat-sensitive paper tape 55 concentrates on the central portion in the tape width direction. As a result, the heat-sensitive paper tape 55 can be stably fed.

The first width direction regulating portions 81A and 81B and the first print surface side regulating portion 81C are formed in the bottom case 31B alone. Therefore, regardless of the fitting state of the top case 31A and the bottom case 31B, the dimensional accuracy of these members is assured. Therefore, the movement of the heat-sensitive paper tape 55 as the print medium in the tape width direction and the movement of the heat-sensitive paper tape 55 toward the print surface side can be appropriately restricted, at a stage immediately before printing. Thus, the center position of printing by the thermal head 10 in the vertical direction and the center position of the heat-sensitive paper tape 55 in the tape width direction can be matched with each other particularly accurately. In addition, the first width direction regulating portions 81A and 81B and the first print surface side regulating portion 81C are provided on the arm rear wall 37 of the arm portion 34 that is conventionally provided in the tape cassette 30. Therefore, space is not used wastefully.

The heat-sensitive paper tape 55 that has been discharged from the exit 34A of the arm portion 34 is supplied to the opening 77, and is fed between the thermal head 10 and the platen roller 15. Then, characters are printed onto the print surface of the heat-sensitive paper tape 55 by the thermal head 10. Following this, the printed heat-sensitive paper tape 55 is further fed toward the tape discharge aperture 49, by the tape feed roller 46 and the movable feed roller 14 moving in concert with each other. Then, the printed heat-sensitive paper tape 55 is cut by the cutting mechanism 17.

The tape cassette 30 according to the second embodiment does not include the second regulating portion 82 that is provided on the front end of the partition wall 43 in the first embodiment, and the third regulating portion 83 that is provided on the tape discharge end 44A in the first embodiment. However, the tape cassette 30 according to the present embodiment may include one or both of the second regulating portion 82 and the third regulating portion 83.

### Third Embodiment

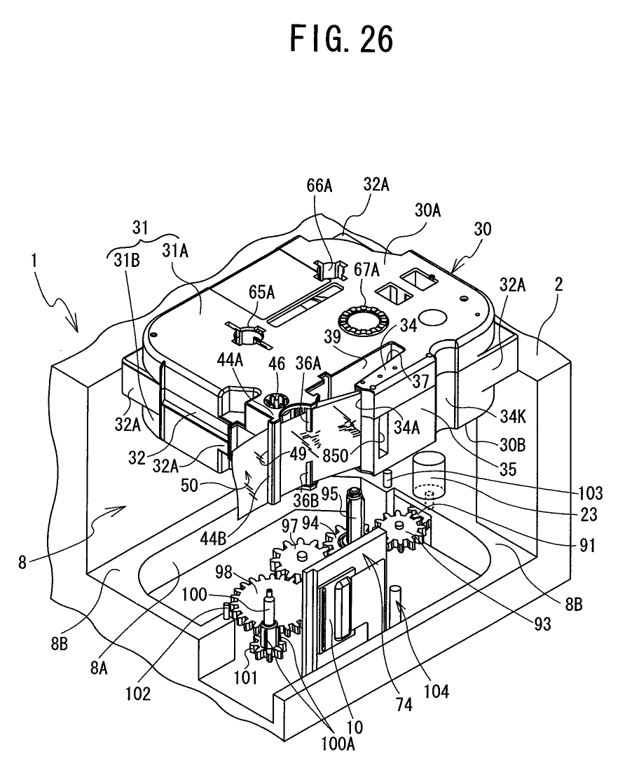

A third embodiment will be explained with reference to FIG. 26 to FIG. 29. In the first embodiment, the head holder 74 of the tape printer 1 includes the two head support portions 74A and 74B located at two positions on the upstream side and the downstream side of the insertion position of the thermal head 10. In the tape cassette 30 according to the first embodiment, corresponding to the head support portions 74A and 74B, the head reception portions 39A and 39B are provided at two positions facing the head insertion portion 39. In the third embodiment, an example will be described in which a support portion of the tape cassette 30 is provided on the upstream side of the head holder 74 only, and the tape cassette 30 is also provided with one support reception portion located at a position facing the head insertion portion 39.

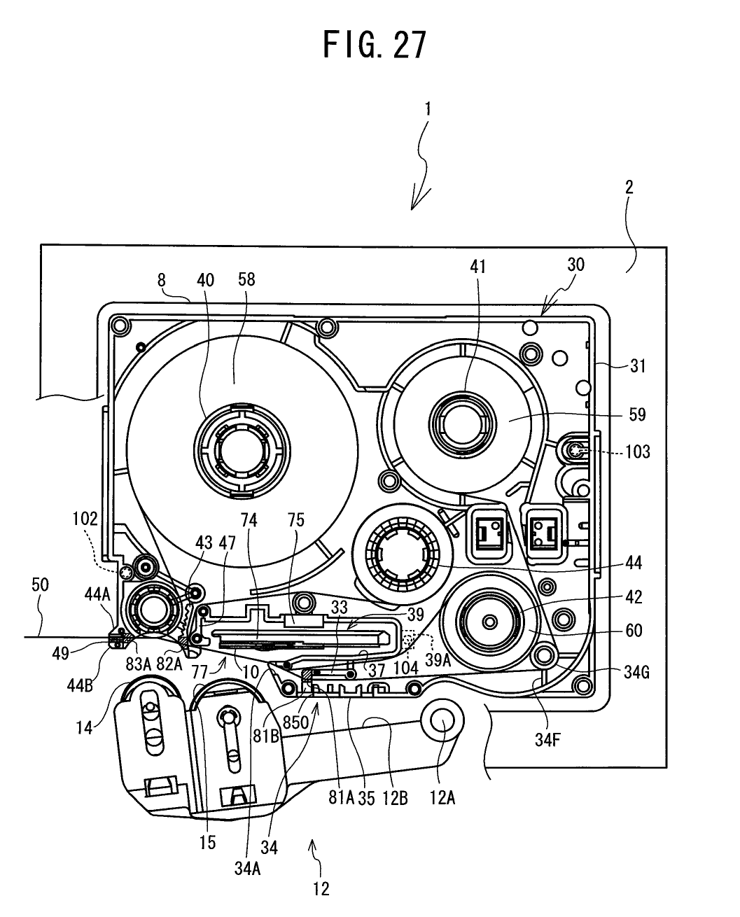

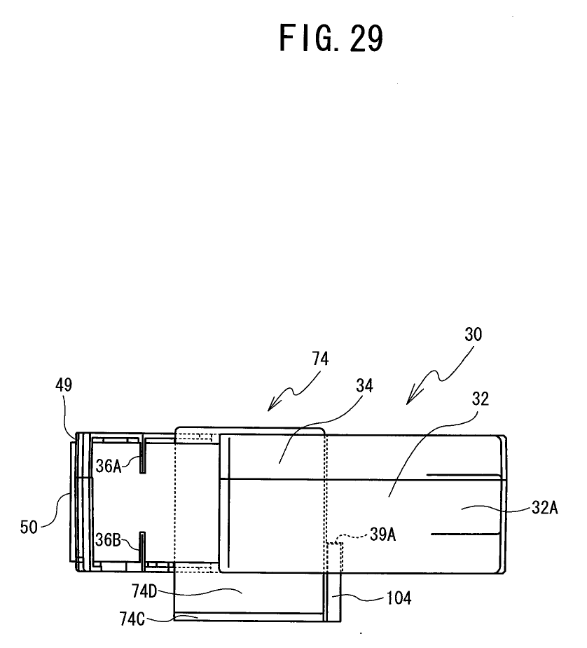

First, the tape printer 1 according to the third embodiment will be explained. As shown in FIG. 26 and FIG. 27, the head holder 74 according to the third embodiment is a plate-shaped member that is provided such that it extends upward from the bottom surface of the cavity 8A of the cassette housing portion 8. More specifically, as shown in FIG. 29, the head holder 74 includes the seat portion 74C, and the head fixing portion 74D. The seat portion 74C is fixed to the bottom surface of the cavity 8A. The head fixing portion 74D is bent at generally a right angle from the seat portion 74C, and extends upward from the bottom surface of the cavity 8A. The head holder 74 is arranged in the cavity 8A such that the head holder 74 opposes the head insertion portion 39 when the tape cassette 30 is installed.

As shown in FIG. 26, unlike the first embodiment (refer to FIG. 3), the head holder 74 according to the third embodiment has a length in the left-right direction shorter than a length in the longitudinal direction (the left-right direction) of the head insertion portion 39. Thus, the head holder 74 can be completely arranged inside the head insertion portion 39. In the third embodiment, the head holder 74 itself does not include a support portion that determines the position of the tape cassette 30 in the vertical direction and supports the tape cassette 30 from underneath. Instead, an upstream support pin 104 is provided adjacent to the right side of the head holder 74, as shown in FIG. 26.

The upstream support pin 104 is a cylindrical member that extends upward from the cavity 8A. When the tape cassette 30 is installed in the tape printer 1, a top surface of the cylindrical member contacts with the upstream reception portion 39A of the tape cassette 30 (which will be described later), thereby supporting the tape cassette 30 from underneath. Accordingly, as shown in FIG. 27, the diameter of the upstream support pin 104 is slightly smaller than a short side of the rectangle, which is the plan shape of the upstream reception portion 39A of the tape cassette 30.

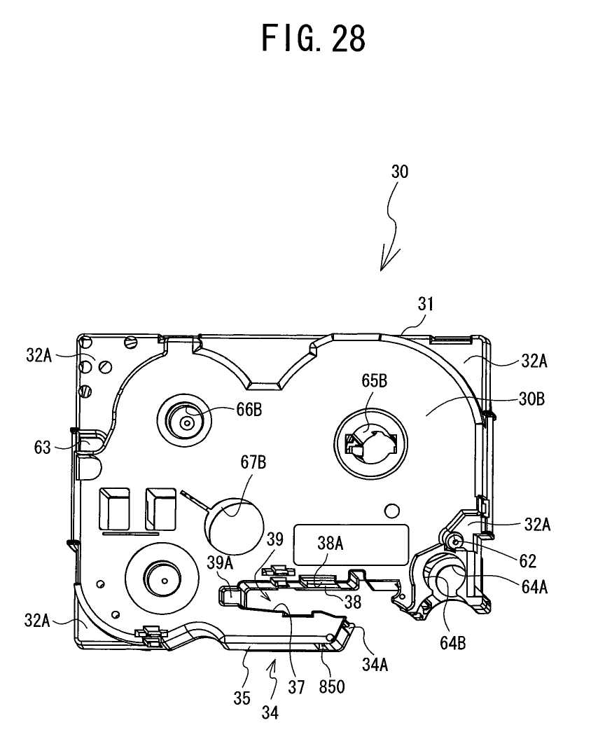

Next, the tape cassette 30 according to the third embodiment will be explained. As shown in FIG. 27 and FIG. 28, the cassette case 31 according to the present embodiment includes the upstream reception portion 39A, at a position facing the head insertion portion 39 on the upstream side in the tape feed direction with respect to the thermal head 10. The upstream reception portion 39A is an indentation provided in the bottom wall 30B. On the other hand, an indentation that serves as a support reception portion is not provided on the downstream side. Other structures of the tape cassette 30 of the third embodiment are the same as those of the first embodiment. More specifically, the tape cassette 30 according to the third embodiment also includes the first regulating portion 81 (only the first width direction regulating portions 81A and 81B are shown in FIG. 27) provided on the separating wall 33 of the arm portion 34, the second regulating portion 82 (only the second upper regulating portion 82A is shown in FIG. 27) provided on the front end of the partition wall 43, and the third regulating portion 83 (only the third upper regulating portion 83A is shown in FIG. 27) provided on the tape discharge end 44A.

Next, operations of the tape cassette 30 and the tape printer 1 when the tape cassette 30 according to the third embodiment is installed in the tape printer 1 will be explained with reference to FIG. 26 and FIG. 29. Note that, the die exit hole 850 of the arm portion 34 is not shown in FIG. 29, in order to simplify the figure.

When the tape cassette 30 is installed in the cassette housing portion 8, the tape cassette 30 is inserted vertically from above such that the bottom wall 30B of the tape cassette 30 opposes the bottom surface of the cavity 8A. The tape cassette 30 is inserted such that the head holder 74, the ribbon take-up shaft 95 and the tape drive shaft 100 that protrude from the bottom surface of the cavity 8A as shown in FIG. 26 are respectively fitted into the head insertion portion 39, the ribbon take-up spool 44 and the shaft hole of the tape feed roller 46. The above-described upstream support pin 104 is provided on the right side of the head holder 74. Further, the upstream reception portion 39A is provided at a corresponding position in the tape cassette 30, more specifically, at a position that faces the head insertion portion 39 and that is on the right side of the head insertion portion 39.

Therefore, when the user pushes the tape cassette 30 downwards, as shown in FIG. 29, the upstream reception portion 39A of the tape cassette 30 comes into contact with the top surface of the upstream support pin 104, and the movement of the upstream reception portion 39A beyond that point in the downward direction is restricted. The tape cassette 30 is held in a state in which the upstream reception portion 39A is supported from underneath by the upstream support pin 104.

In this manner, the tape cassette 30 according to the third embodiment includes the upstream reception portion 39A, at a position immediately before the position where printing is performed on the film tape 59 that is a print medium. As a consequence, positioning in the vertical direction can be achieved, at the most effective position to match the center position of printing by the thermal head 10 in the vertical direction and the center position of the film tape 59 in the tape width direction.

When printing is performed after the tape cassette 30 according to the third embodiment has been installed in the tape printer 1, the operations of the tape cassette 30 and the tape printer 1 are the same as in the first embodiment. In a similar manner to the first embodiment, the tape cassette 30 according to the third embodiment need not be provided with all of the first to third regulating portions 81 to 83. In other words, the tape cassette 30 may include at least one of the first to third regulating portions 81 to 83.

The tape cassette 30 of the present invention is not limited to those in the above-described embodiments, and various modifications and alterations may of course be made. For example, in the above-described embodiments, an example is explained in which the protrusions 81D to 83D are provided on the upper portions of the first to third upper regulating portions 81A to 83A, in the first to third regulating portions 81 to 83. Further, in the top wall 30A of the top case 31A, the fitting holes 81H to 83H that penetrate the top wall 30A are provided at positions that correspond to the respective protrusions 81D to 83D when the top case 31A is joined to the bottom case 31B. However, it may be sufficient if a fitting relationship is established between lower joining portions (that are provided on the upper portions of the first to third upper regulating portions 81A to 83A) and upper joining portions (that are provided to the top wall 31A at positions that correspond to the lower joining portions when the top case 31A is joined to the bottom case 31B). The lower and upper joining portions need not be protrusions and fitting holes.

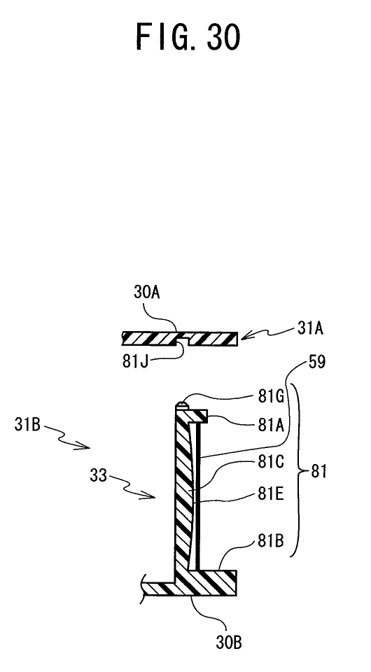

With reference to FIG. 30 to FIG. 32, examples of combinations of the lower joining portion and the upper joining portion that can be adopted will be described below. In the examples shown in FIG. 30 to FIG. 32, the lower joining portion is provided on the upper portion of the first upper regulating portion 81A, and the upper joining portion is provided to the top case 31A, at a position that corresponds to the lower joining portion when the top case 31A is joined to the bottom case 31B.

In the example shown in FIG. 30, a protrusion 81G is formed on the upper portion of the first upper regulating portion 81A, in the first regulating portion 81 provided in the bottom case 31B. The protrusion 81G is shorter than the thickness of the top wall 30A of the top case 31A. An indentation 81J is formed in the top wall 30A of the top case 31A, at a position that corresponds to the protrusion 81G when the top case 31A is joined to the bottom case 31B. Therefore, when the top case 31A is joined to the bottom case 31B, the protrusion 81G of the bottom case 31B is fitted into the indentation 81J of the top case 31A, thereby fixing the top case 31A and the bottom case 31B together.

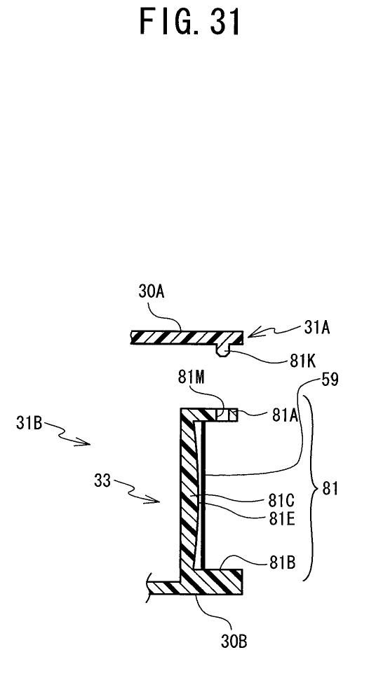

In the example shown in FIG. 31, a fitting hole 81M, which is a through-hole, is formed in the first upper regulating portion 81A, in the first regulating portion 81 provided in the bottom case 31B. A protrusion 81K is formed on the lower surface of the top wall 30A of the top case 31A, at a position that corresponds to the fitting hole 81M when the top case 31A is joined to the bottom case 31B. Therefore, when the top case 31A is joined to the bottom case 31B, the protrusion 81K of the top case 31A is fitted into the fitting hole 81M of the bottom case 31B, thereby fixing the top case 31A and the bottom case 31B together.

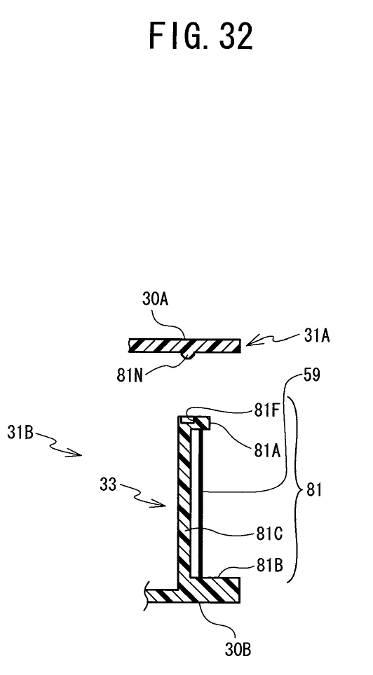

In the example shown in FIG. 32, an indentation 81F is formed in the upper portion of the first upper regulating portion 81A, in the first regulating portion 81 provided in the bottom case 31B. A protrusion 81N is formed on the lower surface of the top wall 30A of the top case 31A, at a position that corresponds to the indentation 81F when the top case 31A is joined to the bottom case 31B. Therefore, when the top case 31A is joined to the bottom case 31B, the protrusion 81N of the top case 31A is fitted into the indentation 81F of the bottom case 31B, thereby fixing the top case 31A and the bottom case 31B together.

Although the first regulating portion 81 is used as an example in FIG. 30 to FIG. 32, similar combinations may be adopted for the second regulating portion 82 and the third regulating portion 83.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A tape cassette comprising:
a housing including a top case and a bottom case, the top case including a top wall, and the bottom case including a bottom wall and a bottom outer wall extending from the bottom wall toward the top wall;
a tape wound and mounted within the housing, the tape being a print medium;
a printer head insertion portion that is a space extending through the housing in a direction perpendicular to the bottom wall and having an oblong rectangular cross-sectional shape, the oblong rectangular shape extending parallel to the front wall;
an arm portion including a first wall portion and a second wall portion and directing the tape along a feed path between the first wall portion and the second wall portion to an exit, the first wall portion being a section of the bottom outer wall, the second wall portion being disposed between the first wall portion and the printer head insertion portion, and extending perpendicularly upwards from the bottom wall;
a first width direction regulating portion provided on the second wall portion to restrict a movement of the tape in a tape width direction;
a first print surface side regulating portion provided on the second wall portion to restrict the movement of the tape toward a print surface side of the tape, bend the feed path of the tape toward the printer head insertion portion, and guide the tape to be discharged from the exit to the outside of the arm portion;
a first lower joining portion provided on an upper end of the first width direction regulating portion; and
a first upper joining portion provided on the top case to join with the first lower joining portion at a position that corresponds to a position of the first lower joining portion when the top case and the bottom case are joined.

2. The tape cassette according to claim 1, wherein:
the first print surface side regulating portion includes a bending portion adapted to contact a print surface of the tape to bend the feed path of the tape toward the printer head insertion portion; and
a center of the bending portion in the tape width direction protrudes toward the first wall portion.

3. The tape cassette according to claim 1, wherein:
the first lower joining portion is any one of a protrusion, an indentation, and a through-hole;
the first upper joining portion is any one of an indentation that can be fitted with the protrusion, a through-hole that can be fitted with the protrusion, a protrusion that can fit in the indentation, and a protrusion that can fit in the through-hole.

4. The tape cassette according to claim 1, further comprising an ink ribbon for printing on the tape and wound and mounted within the housing,
wherein:
the arm portion includes a third wall portion disposed between the second wall portion and the printer head insertion portion, and extending perpendicularly from the bottom wall toward the top wall; and
the arm portion directs the tape between the first wall portion and the second wall portion, and directs the ink ribbon between the second wall portion and the third wall portion.

5. The tape cassette according to claim 1, further comprising:
a guide portion that directs the tape discharged from the exit of the arm portion toward a downstream side in a feed direction of the tape;
a second width direction regulating portion provided on the bottom case at the downstream side of the guide portion in the feed direction to restrict the movement of the tape in the tape width direction;
a second print surface side regulating portion provided on the bottom case at a downstream side of the guide portion in the feed direction to restrict the movement of the tape toward the print surface side of the tape;
a second lower joining portion provided on an upper end of the second width direction regulating portion; and
a second upper joining portion provided on the top case to join with the second lower joining portion at a position that corresponds to a position of the second lower joining portion when the top case and the bottom case are joined.

6. The tape cassette according to claim 5, further comprising:
an ink ribbon for printing on the tape and wound and mounted within the housing; and
a separating portion that separates the tape and the ink ribbon directed through the arm portion and discharged from the exit of the arm portion,
wherein the second width direction regulating portion and the second print surface side regulating portion are provided on the bottom case at a downstream side of the separating portion in the feed direction.

7. The tape cassette according to claim 5, wherein:
the second print surface side regulating portion includes protrusions respectively provided at an upper end and a lower end of the second print surface side regulating portion in the tape width direction, the protrusions protruding toward the feed path of the tape; and
only the protrusions of the second print surface side regulating portion contacting the print surface of the tape.

8. The tape cassette according to claim 5, wherein:
the second lower joining portion is any one of a protrusion, an indentation, and a through-hole;
the second upper joining portion is any one of an indentation that can be fitted with the protrusion, a through-hole that can be fitted with the protrusion, a protrusion that can fit in the indentation, and a protrusion that can fit in the through-hole.

9. The tape cassette according to claim 1, further comprising:
a tape feed roller rotatably disposed within the housing at a downstream side of the printer head insertion portion in the feed direction to draw out the tape;
a third width direction regulating portion provided on the bottom case at a downstream side of the tape feed roller in the feed direction to restrict the movement of the tape in the tape width direction;
a third lower joining portion provided on an upper end of the third width direction regulating portion; and
a third upper joining portion provided on the top case to join with the third lower joining portion at a position that corresponds to a position of the third lower joining portion when the top case and the bottom case are joined.

10. The tape cassette according to claim 9, wherein the tape feed roller includes an engaging portion that is provided at a lower portion of the tape feed roller in the tape width direction and that is adapted to be engaged with a drive cam of the tape printer.

11. The tape cassette according to claim 9, wherein:
the third lower joining portion is any one of a protrusion, an indentation, and a through-hole;
the third upper joining portion is any one of an indentation that can be fitted with the protrusion, a through-hole that can be fitted with the protrusion, a protrusion that can fit in the indentation, and a protrusion that can fit in the through-hole.

12. A tape cassette comprising:
a housing including a top case and a bottom case, the top case including a top wall and the bottom case including a bottom wall and a bottom outer wall extending from the bottom wall toward the top wall;
a tape wound and mounted within the housing, the tape being a print medium;
a printer head insertion portion that is a space extending through the housing in a direction perpendicular to the bottom wall and having an oblong rectangular cross-sectional shape, the oblong rectangular shape extending parallel to the front wall;
an arm portion including a first wall portion and a second wall portion and directing the tape along a feed path between the first wall portion and the second wall portion to an exit, the first wall portion being a section of the bottom outer wall, the second wall portion being disposed between the first wall portion and the printer head insertion portion, and extending perpendicularly upwards from the bottom wall;
a guide portion that directs the tape discharged from the exit of the arm portion toward a downstream side in a feed direction of the tape;
a width direction regulating portion provided on the bottom case at a downstream side of the guide portion in the tape feed direction to restrict a movement of the tape in a tape width direction;
a print surface side regulating portion provided on the bottom case at a downstream side of the guide portion in the tape feed direction to restrict the movement of the tape toward a print surface side of the tape;
a lower joining portion provided on an upper end of the width direction regulating portion; and
an upper joining portion provided on the top case to join with the lower joining portion at a position that corresponds to a position of the lower joining portion when the top case and the bottom case are joined.

13. The tape cassette according to claim 12, further comprising:
an ink ribbon for printing on the tape and wound and mounted within the housing; and
a separating portion that separates the tape and the ink ribbon directed through the arm portion and discharged from the exit of the arm portion,
wherein the width direction regulating portion and the print surface side regulating portion are provided on the bottom case at a downstream side of the separating portion in the feed direction.

14. The tape cassette according to claim 12, wherein:
the print surface side regulating portion includes protrusions respectively provided at an upper end and a lower end of the print surface side regulating portion in the tape width direction, the protrusions protruding toward the feed path of the tape; and
only the protrusions of the print surface side regulating portion contact the print surface of the tape.

15. The tape cassette according to claim 12, wherein:
the lower joining portion is any one of a protrusion, an indentation, and a through-hole;
the upper joining portion is any one of an indentation that can be fitted with the protrusion, a through-hole that can be fitted with the protrusion, a protrusion that can lit in the indentation, and a protrusion that can fit in the through-hole.

16. A tape cassette comprising:
a housing including a top case and a bottom case the lop case including a top wall, and the bottom case including a bottom wall and a bottom outer wall extending from the bottom wall toward the top wall;
a tape wound and mounted within the housing, the tape being a print medium;
a printer head insertion portion that is a space extending through the housing in a direction perpendicular to the bottom wall and having an oblong rectangular cross-sectional shape, the oblong rectangular shape extending parallel to the front wall;
an arm portion including a first wall portion and a second wall portion and directing the tape along a feed path between the first wall portion and the second wall portion to an exit, the first wall portion being a section of the bottom outer wall, the second wall portion being disposed between the first wall portion and the printer head insertion portion, and extending perpendicularly upwards from the bottom wall;
a tape feed roller rotatably disposed within the housing at a downstream side of the printer head insertion portion in a feed direction to draw out the tape;
a width direction regulating portion provided on the bottom case at a downstream side of the tape feed roller in the feed direction to restrict the movement of the tape in the tape width direction;
a lower joining portion provided on an upper end of the width direction regulating portion; and
an upper joining portion provided on the top case to join with the lower joining portion at a position that corresponds to a position of the lower joining portion when the top case and the bottom case are joined.

17. The tape cassette according to claim 16, wherein:
the lower joining portion of the third tape width direction regulating portion is any one of a protrusion, an indentation, and a through-hole;
the upper joining portion of the top case is any one of an indentation that can be fitted with the protrusion, a through-hole that can be fitted with the protrusion, a protrusion that can fit in the indentation, and a protrusion that can fit in the through-hole.
